(19) United States
(12) Patent Application Publication
(10) Pub. No.: US 2017/0109298 A1
(43) Pub. Date: Apr. 20, 2017

(54) STORAGE SYSTEM THAT INCLUDES A PLURALITY OF ROUTING CIRCUITS AND A PLURALITY OF NODE MODULES CONNECTED THERETO

(71) Applicant: KABUSHIKI KAISHA TOSHIBA, Tokyo (JP)

(72) Inventors: Takahiro Kurita, Sagamihara Kanagawa (JP); Atsuhiro Kinoshita, Kamakura Kanagawa (JP); Kazunari Kawamura, Akishima Tokyo (JP); Kazunari Sumiyoshi, Yokohama Kanagawa (JP); Hisaki Niikura, Nakano Tokyo (JP)

(21) Appl. No.: 15/063,273

(22) Filed: Mar. 7, 2016

Related U.S. Application Data
(60) Provisional application No. 62/241,828, filed on Oct. 15, 2015.

(51) Int. Cl. G06F 13/16; G06F 13/40

(52) U.S. Cl. CPC G06F 13/1668; G06F 13/4068

(57) ABSTRACT

A storage device includes a storage unit having a plurality of routing circuits networked with each other, each of the routing circuits configured to route packets to a plurality of node modules that are connected thereto, each of the node modules including nonvolatile memory, and a plurality of connection units, each coupled with one or more of the routing circuits, and configured to access each of the node modules through one or more of the routing circuits. Each of the connection units is configured to transmit an inquiry to a target node module, to initiate a write operation, and determine whether or not to transmit a write command based on a notice returned by the target node module in response to the inquiry.

### CROSS-REFERENCE TO RELATED APPLICATION

This application is based upon and claims the benefit of priority from U.S. Provisional Patent Application No. 62/241,828, filed on Oct. 15, 2015, the entire contents of which are incorporated herein by reference.

### FIELD

Embodiments described herein relate generally to a storage system, in particular, a storage system that includes a plurality of routing circuits and a plurality of node modules connected thereto.

### BACKGROUND

A storage system of one type is connected to a plurality of clients and stores data in accordance with requests received from the clients. The storage system may include a plurality of non-volatile memories such as flash memories for the data storage. However, if a plurality of accesses is concentrated on particular one of the non-volatile memories, congestion of data traffic may occur in a communication path from an interface which receives a request from the client to the non-volatile memory, and a writing performance of the storage system may be compromised.

### BRIEF DESCRIPTION OF THE DRAWINGS

FIG. 1 illustrates a storage system according to an embodiment.

FIG. 2 illustrates a configuration of a connection unit (CU).

FIG. 3 illustrates a configuration of a plurality of a field-programmable gate arrays (FPGA), each including a plurality of node modules (NM).

FIG. 4 illustrates a configuration of the FPGA.

FIG. 5 illustrates a configuration of the NM.

FIG. 6 illustrates a data structure of a packet.

FIG. 7 illustrates a transmission operation of a verification packet according to a first embodiment.

FIG. 8 illustrates a transmission operation of a response packet in response to the verification packet according to the first embodiment.

FIG. 9 is a sequence diagram illustrating operations of the CU and the NM according to the first embodiment.

FIG. 10 is a flowchart illustrating the operation of the NM according to the first embodiment.

FIG. 11 is a sequence diagram illustrating operations of the CU and the NM according to a second embodiment.

FIG. 12 is a flowchart illustrating an operation of the NM according to the second embodiment.

FIG. 13 is a sequence diagram illustrating operations of the CU and the NM according to a third embodiment.

FIG. 14 is a flowchart illustrating an operation of the NM according to the third embodiment.

FIG. 15 illustrates a data transmission operation of the CU and the NM according to a fourth embodiment.

FIG. 16 illustrates a transmission operation of a reservation packet by the CU according to the fourth embodiment.

FIG. 17 illustrates a transmission operation of a reservation packet by the CU according to the fourth embodiment.

FIG. 18 illustrates a transmission operation of a response packet by the NM according to the fourth embodiment.

FIG. 19 illustrates a transmission operation of a write request by the CU according to the fourth embodiment.

FIG. 20 illustrates a transmission operation of a right transfer notice and a transmission operation of a write request by the CU according to the fourth embodiment.

FIG. 21 is a sequence diagram illustrating operations of the CU and the NM according to the fourth embodiment.

FIG. 22 illustrates a transmission operation of a congestion confirmation packet by the CU according to a fifth embodiment.

FIG. 23 illustrates a transmission operation of a response packet by the NM according to the fifth embodiment.

FIG. 24 illustrates a transmission operation of a write request by the CU according to the fifth embodiment.

FIG. 25 is a flowchart illustrating an operation of the CU according to the fifth embodiment.

FIG. 26 is a flowchart illustrating an operation of the NM according to the fifth embodiment.

### DETAILED DESCRIPTION

According to an embodiment, a storage device includes a storage unit having a plurality of routing circuits networked with each other, each of the routing circuits configured to route packets to a plurality of node modules that are connected thereto, each of the node modules including nonvolatile memory, and a plurality of connection units, each communication with one or more of the routing circuits for communication therewith, and configured to access each of the node modules through one or more of the routing circuits. Each of the connection units is configured to transmit an inquiry to a target node module, to initiate a write operation, and determine whether or not to transmit a write command based on a notice returned by the target node module in response to the inquiry.

Embodiments of a storage system will be described below, with reference to the drawings.

### First Embodiment

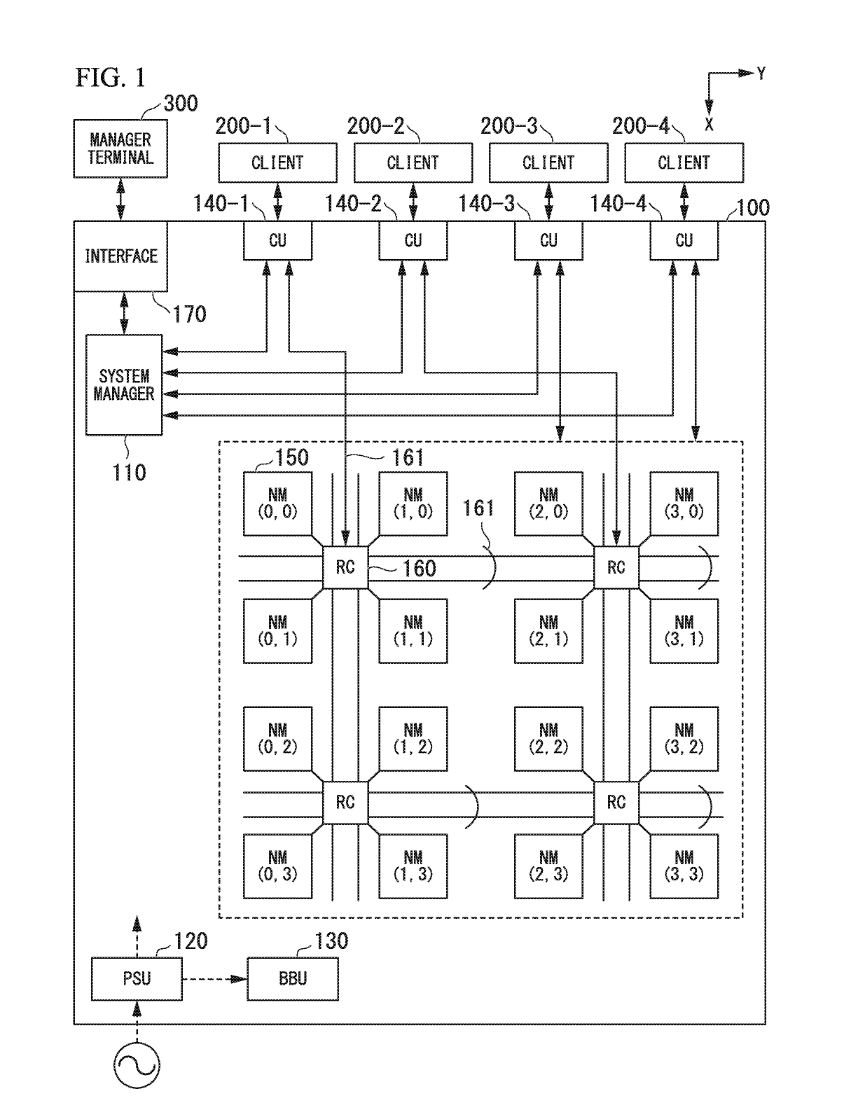

FIG. 1 illustrates a storage system 100 according to a first embodiment. First, an outline of the storage system 100 will be described with reference to FIG. 1.

The storage system 100 may include a system manager 110, a power supplying unit (PSU) 120, a battery backup unit (BBU) 130, connection units (CUs) 140-1 to 140-n (n: arbitrary natural number), node modules (NMs) 150, a routing circuit (RC) 160, and an interface 170, but not limited thereto. Hereinafter, if each of the CU is not distinguished, each of them is simply described as a CU 140.

The system manager 110 may be implemented by a processor such as a CPU (central processing unit) which executes a program stored in a program memory. The system manager 110 may be also implemented in hardware such as a large scale integration (LSI) and an ASIC application specific integrated circuit (ASIC) which has the same function as the processor which executes the program. For example, the system manager 110 records a status of the CU 140, resets, and manages a power source.

The PSU 120 converts an external power voltage, which is supplied from an external power source, to a predetermined direct voltage, and the PSU 120 supplies the direct voltage to components of the storage system 100. For example, the external power source is an alternating-current power source of which voltage is 100 [V] or 200 [V].

The BBU 130 includes a secondary battery, and accumulates electric power which is supplied from the PSU 120. If the storage system 100 is electrically disconnected from the external power source, the BBU 120 supplies an auxiliary power voltage to components of the storage system 100. A node controller (NC) 151 of the NM 150, which will be described below, performs backup for protecting data using the auxiliary power voltage.

The CU 140 is a connector which is connectable to one or more client 200-1 to 200-n (n: arbitrary natural number). Hereinafter, if each the client is not distinguished, each of them is simply described as a client 200. The client 200 is used by a user of the storage system 100. The client 200 transmits, to a CU 140, a command such as a read command, a write command, and a remove command with respect to the storage system 100. The CU 140 receives these commands, and transmits a request, which corresponds to a received command, to the NM 150 of which address corresponds to address information included in the command, via a communication network of the RCs 160, which will be described below. The CU 140 obtains data, which are requested by a read request, from the NM 150, and transmits the obtained data to the client 200.

The NM 150 includes a non-volatile memory. The NM 150 is a storage which stores data in accordance with an instruction from the client 200. A configuration of the NM 150 will be described below.

For example, the storage system 100 includes a plurality of RCs 160 arranged in a matrix configuration. The matrix is an arrangement in which the composition elements are arranged in a first direction and a second direction which is perpendicular to the first direction. A torus routing is an arrangement, described below, in which the NMs 150 are connected in a torus form.

The RC 160 transmits a packet, which includes data transmitted from the CU 140 or another RC 160, by using a mesh-shaped network. The mesh-shaped network is a network which is formed into a mesh shape or a grid shape. Specifically, the mesh-shaped network is a network in which the RCs 160 are arranged at intersections where vertical lines and horizontal lines intersect. The vertical lines and horizontal lines are communication paths. Each of the RCs 160 includes two or more RC interfaces 161. The RC 160 is electrically connected to each of one or more adjacent RCs 160 via the RC interface 161.

The system manager 110 is electrically connected to the CUs 140 and the RCs 160 of desired number. Each of the NMs 150 is electrically connected to adjacent NMs 150 via the RC 160 and a packet management unit (PMU) 180, which will be described below, and configures the NMs 150 as a RAID (redundant array of inexpensive disks).

FIG. 1 illustrates a configuration of a rectangular network in which each of the NMs 150 is disposed at a grid point. A coordinate of the grid point is represented as (x, y) of decimal number coordinate. Position information of the NM 150, which is disposed at a grid point, is represented as a relative node address (xD, yD) (=decimal number) corresponding to a coordinate of the grid point. In FIG. 1, the NM 150 positioned at an upper-left corner has a node address (0, 0) of an origin. The relative node address of the NM 150 varies in accordance with a change of an integer value of a horizontal direction (X direction) and a vertical direction (Y direction).

Each of the NMs 150 is connected to NMs 150 adjacent in two or more directions. For example, the NM 150 (0, 0) positioned at the upper-left corner is connected, via the RC 160, to the NM 150 (1,0) which is adjacent in the X direction, the NM 150 (0,1) which is adjacent in the Y direction different from the X direction, and the NM 150 (1,1) which is adjacent in a diagonal direction.

In FIG. 1, each of the NMs 150 is disposed at the grid point of the rectangular grid, but not limited thereto. For example, if each of the NMs 150 positioned at the grid point is connected to NMs 150 adjacent in two or more directions, the shape of the grid may be, for example, a triangular shape or a hexagonal shape. In FIG. 1, although the NMs 150 are two-dimensionally arranged, the NMs 150 may be three-dimensionally arranged. If the NMs 150 are three-dimensionally arranged, each of the NMs 150 can be specified by using three values (x, y, z). If the NMs 150 are two-dimensionally arranged, the NM 150 may be connected in a torus form by connecting the NMs 150 which are positioned at opposite sides.

The torus form is a connection form in which the NMs 150 are circularly connected and at least two paths exist as paths from one NM 150 to another NM 150. The two paths include a first path in a first direction and a second path in a direction opposite to the first direction.

In FIG. 1, the storage system 100 includes four CUs 140-1 to 140-4. Each of the CUs 140 is connected to a different RC 160 in a one to one relationship. When the CU 140 processes a command from the client 200, in order to access a NM 150, the CU 140 generates a packet which can be transmitted and executed by the RC 160, and the CU 140 transmits the generated packet to the RC 160 which is connected thereto.

The number of the CUs 140 can be arbitrarily selected. Each of the CUs 140 may be connected to a plurality of the RCs 160, and each of the RCs 160 may be connected to a plurality of the CUs 140.

The interface 170 connects the system manager 110 and a manager terminal 300. The manager terminal 300 is a terminal device used by an administrator that manages the storage system 100. The manager terminal 300 provides an interface such as a GUI (Graphical User Interface) to the administrator. The manager terminal 300 transmits, to the system manager 110, an instruction with respect to the storage system 100.

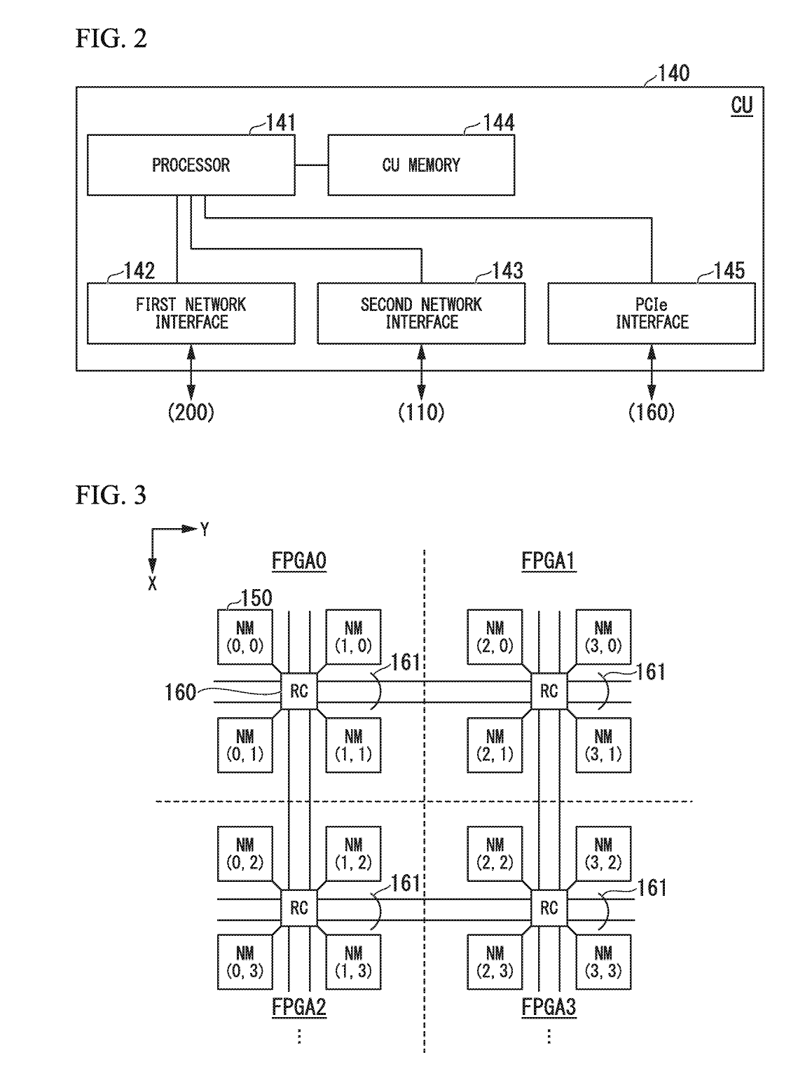

FIG. 2 illustrates a configuration of the CU 140. The CU 140 may include a processor 141 such as a CPU, a first network interface 142, a second network interface 143, a CU memory 144, and a PCIe interface 145, but not limited thereto.

The processor 141 performs various types of processes by executing an application program, using the CU memory 144 as a work area. The first network interface 142 is a connection interface which is connected to the client 200. The second network interface 143 is a connection interface which is connected to the system manager 110. The CU memory 144 is a memory which temporarily stores data. For example, the CU memory 144 is a RAM, but various types of memories may be used. The CU memory 144 may include a plurality of memories. The PCIe interface 145 is a connection interface which is connected to the RC 160.

FIG. 3 illustrates a configuration of an array of field-programmable gate arrays (FPGA), each including one NM 150. For example, the storage system 100 includes a plurality of FPGAs. Each of the FPGAs includes one RC 160 and four NMs 150. In FIG. 3, the storage system 100 includes four FPGAs 0 to 3. For example, the FPGA 0 includes one RC 160, and four NMs (0, 0), (1, 0), (0, 1), and (1, 1).

For example, each of addresses of the four FPGAs 0 to 3 are represented as (000, 000), (010, 000), (000, 010), and (010, 010), using binary numbers.

One RC 160 and four NMs, which are in each of the FPGAs, are electrically connected to the RC interface 161 via the PMU 180 which will be described below. During a data transmission operation, the RC 160 performs routing with reference to addresses x and y of an FPGA address.

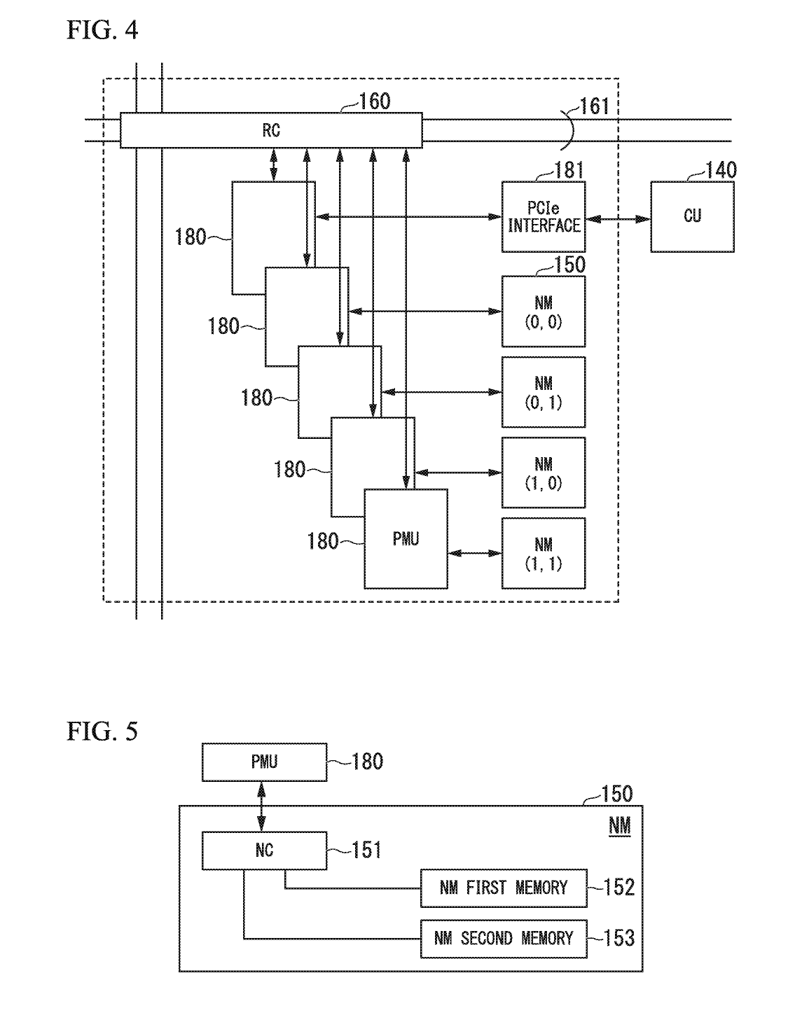

FIG. 4 illustrates a configuration of the FPGA. The structure shown in FIG. 4 is common to the FPGAs 0 to 3. For example, the FPGA may include one RC 160, four NMs 150, five packet management units (PMU) 180, and a PCIe interface 181, but not limited thereto.

Four PMUs 180 are disposed with respect to the four NMs 150, and one PMU 180 is disposed with respect to the PCIe interface 181. Each of the four PMUs 180 analyzes a packet which is transmitted from the CU 140 and the RC 160. Each of the four PMUs 180 determines whether or not a coordinate (relative node address) included in the packet corresponds to an own coordinate (relative node address). If the coordinate included in the packet corresponds to the own coordinate, the PMU 180 directly transmits the packet to the corresponding NM 150. On the other hand, if the coordinate included in the packet does not correspond to the own coordinate (in a case of another coordinate), the PMU 180 transmits the determination to the RC 160.

For example, if a node address of a final destination is (3, 3), the PMU 180, which is connected to the node address (3, 3), determines that the coordinate (3, 3) described in the analyzed packet corresponds to the own coordinate (3, 3). Then, the PMU 180, which is connected to the node address (3, 3), transmits the analyzed packet to the NM 150 of the node address (3, 3) which is connected thereto. The transmitted packet is analyzed by the NC 151 (described below) of the NM 150. Thereby, the FPGA performs processing in accordance with a request described in the packet. For example, the FPGA stores the data in the non-volatile memory disposed in the NM 150 by using the NC 151.

The PCIe interface 181 transmits a request and a packet, which are from the CU 140, to the PMU 180. The RC 160 analyzes the request and the packet stored in the PMU 180. The RC 160 may transmit the request and the packet to another RC 160 in accordance with a result of the analysis.

FIG. 5 illustrates a configuration of the NM. An embodiment of the NM will described below. The NM 150 may include an NC 151, an NM first memory 152 which functions as a non-volatile memory, and an NM second memory 153 which is used as a working area by the NC 151, but not limited thereto.

The NC 151 is electrically connected to the PMU 180. The NC 151 receives a packet from the CU 140 or another NM 150 via the PMU 180. The NC 151 transmits a packet to the CU 140 or another NM 150 via the PMU 180. The NC 151 performs processing in accordance with a request included in the packet which is received from the PMU 180. For example, if the request included in the packet is an access request (read request or write request), the NC 151 accesses the NM first memory 152.

For example, the NM first memory 152 may be a NAND-type flash memory, a bit cost scalable memory (BiCS), a magnetoresistive random access memory (MRAM), a phase change random access memory (PcRAM), a resistance random access memory (RRAM®), or a combination thereof.

The NM second memory 153 is not a non-volatile memory, and temporarily stores data. The NM second memory 153 may be various type of RAM such as a dynamic random access memory (DRAM). If the NM first memory 152 functions as a working area, the NM second memory 153 may not be disposed in the NM 150.

In general, the NM first memory 152 is non-volatile memory and the NM second memory 153 is volatile memory. Further, in one embodiment, the read/write performance of the NM second memory 153 is better than that of the NM first memory 152.

In this way, the RC 160 is connected to the RC interface 161, and the RC 160 is connected to the NM 150 via the PMU 180. Thereby, the communication network of the RCs 160 is formed, but limited thereto. For example, the communication network may be formed by directly connecting each of the NMs 150 without using the RC 160.

An interface standard used in the storage system according to the present embodiment is described below. In the present embodiment, following standards can be employed for the interface which electrically connects the components described above.

First, a low voltage differential signaling (LVDS) standard can be employed for the RC interface 161 which connects the RCs 160. A PCIe (PCI Express) standard can be employed for the RC interface 161 which electrically connects the RC 160 and the CU 140. These interface standards are examples. If necessary, another interface standard can be employed.

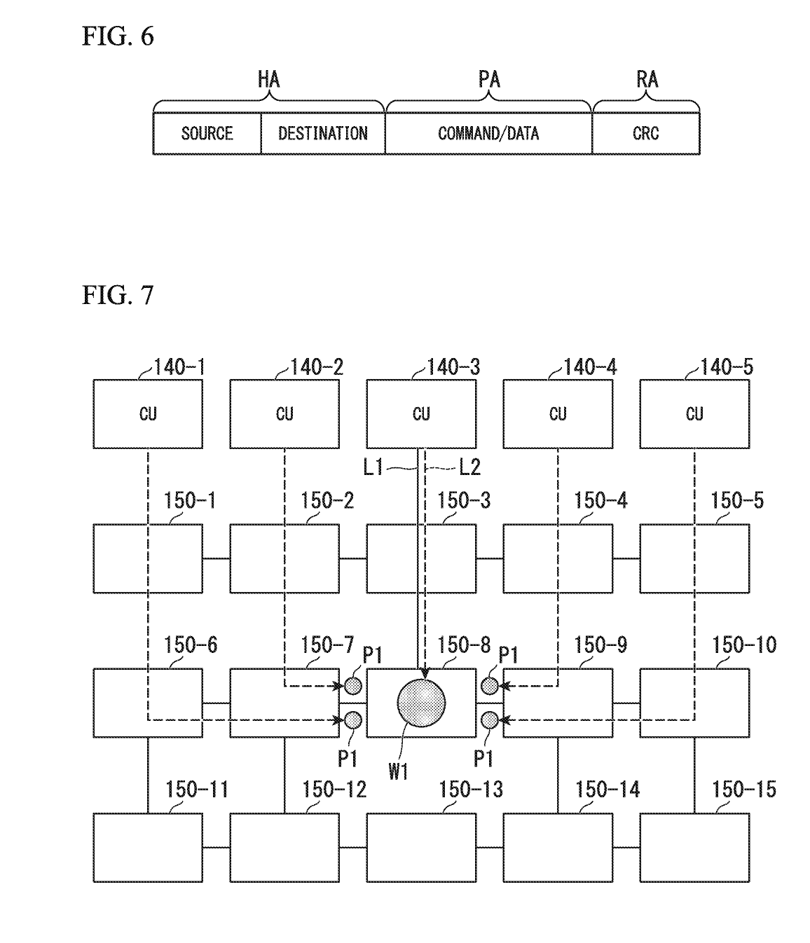

FIG. 6 illustrates an example of the packet. The packet, which is transmitted in the storage system 100 in the present embodiment, may include a header area HA, a payload area PA, and a redundant area RA, but not limited thereto.

In the header area HA, for example, an address (from_x, from_y) of the x and y directions of a source and an address (to_x, to_y) of the x and y directions of a destination are described. In the payload area PA, for example, a command and data are described. A data size of the payload area PA is changeable. In the redundant area RA, for example, a CRC (Cyclic Redundancy Check) code is described. The CRC code is a code (information) for detecting an error of data in the payload area PA.

The RC 160, which receives the packet having the components shown in FIG. 6, determines a routing destination based on a predetermined transfer algorithm. In accordance with the transfer algorithm, the packet is transferred through the RCs 160. Thereafter, the packet reaches the NM 150 of which node address corresponds to a final destination.

For example, in accordance with the transfer algorithm, the RC 160 determines, as a transfer destination, a NM 150 which is positioned along a path through which a number of transfer of the packet from the own NM 150 to the final destination is minimum. In accordance with the transfer algorithm, if there is a plurality of paths along which the number of transfer of the packet from the own NM 150 to the final destination is minimum, the RC 160 selects one of the paths using an arbitrary method. If a NM 150 positioned along the path through which the number of transfer is minimum is broken down or busy, the RC 160 changes the transfer destination to another NM 150.

Because the NMs 150 are logically connected to form the mesh-shaped network, a plurality of paths through which the number of transfer of the packet is minimum may exist. In this case, if a plurality of packets of which destination is a same particular NM 150 is output, the output packets are dispersedly transmitted through different one of the plurality of paths in accordance with the transfer algorithm. Therefore, concentration of access on a particular NM 150 can be avoided, and reduction of throughput of the entire storage system 100 can be suppressed.

FIG. 7 illustrates a transmission operation of a verification packet according to the first embodiment. In FIG. 7, the RC 160, the PMU 180, and so on are omitted in order to precisely describe a transmission operation performed by the NM 150 and the CU 160. As described above, the routing of a packet is performed by the RC 160. As shown in FIG. 7, the NMs 150-1 to 150-15 are connected through the communication network of the RCs 160. The CUs 140-1 to 140-5 are connected to the NMs 150-1 to 150-5, respectively.

The NM 150-8 writes data in the NM first memory 152 thereof based on a write request W1 which is transmitted from the CU 140-3. If the NM 150-8 receives a new write request, the NM 150-8 temporarily stores the received write request in the NM second memory 153 thereof. If a plurality of write requests is stored in the NM second memory 153 of the NM 150-8 and the NM 150-8 cannot receive further write requests, the write requests are stored in the PMU 180 of the FPGA which is adjacent to the NM 150-8. The non-received requests may cause congestion in communication paths from each the CUs 140 to the NM 150-8, and a writing performance of the storage system 100 may be compromised.

For the reason, in the present embodiment, for example, if each of the CUs 140-1, 140-2, 140-4, and 140-5 is to transmit a write request to the NM 150-8, each of the CUs 140-1, 140-2, 140-4, and 140-5 transmits, to the NM 150-8, a verification packet P1 for verifying a load of the NM 150-8 before transmitting the write request. The verification packet P1 contains content shown in FIG. 6. For example, a source address and a destination address are described in the header area HA of the verification packet P1. For example, data for representing that this packet is a verification packet is described in the payload area PA of the verification packet P1. For example, a CRC code is described in the redundant area RA of the verification packet P1.

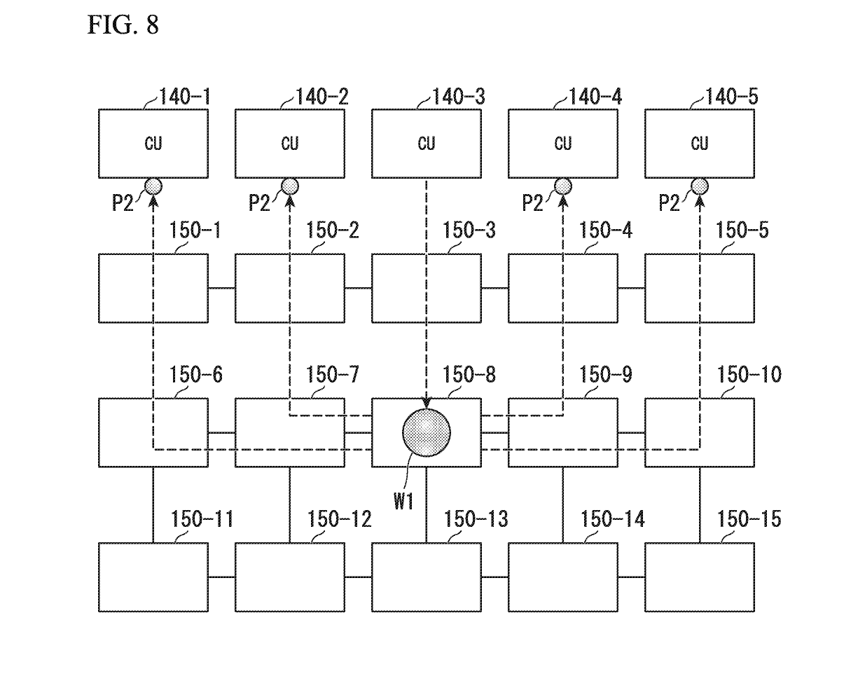

FIG. 8 illustrates a transmission operation of a response packet with respect to the verification packet according to the first embodiment. If the NM 150-8 receives the verification packets P1 from the CUs 140-1, 140-2, 140-4, and 140-5, the NM 150-8 generates response packets P2 with respect to the verification packets P1.

If the NM 150-8 determines that the number of the write requests, which are stored in the NM second memory 153, is less than a reference value (if the load of the NM 150-8 is less than a reference value), the NM 150-8 generates a response packet P2 which indicates that a transmission of the write request is accepted (OK). On the other hand, if the NM 150-8 determines that the number of the write requests, which are stored in the NM second memory 153, is equal to or more than the reference value (if the load of the NM 150-8 is equal to or more than the reference value), the NM 150-8 generates a response packet P2 which indicates that a transmission of the write request is not accepted (NG).

The NM 150-8 transmits the generated response packets P2 to the CUs 140-1, 140-2, 140-4, and 140-5, which are sources of the verification packet P1. Each of these CUs 140 verifies the load of the NM 150-8 in accordance with the response packet P2 which is received from the NM 150-8.

The response packet P2 has the data components shown in FIG. 6. For example, a source address and a destination address are described in the header area HA of the response packet P2. For example, data for indicating that the packet is a response packet is described in the payload area PA of the response packet P2. For example, a CRC code is described in the redundant area RA of the response packet P2.

If each of the CUs 140-1, 140-2, 140-4, and 140-5 receives the response packet P2 which indicates that a transmission of a write request is accepted (OK), each of the CUs 140-1, 140-2, 140-4, and 140-5 transmits a write request. For example, the CU 140-1 generates a write request and transmits the write request to the NM 150-1. If the NM 150-1 received the write request, the NM 150-1 transmits, to the NM 150-6, the write request having a destination address of the NM 150-8. If the NM 150-6 received the write request from the NM 150-1, the NM 150-6 transmits the write request to the NM 150-7. If the NM 150-7 received the write request from the NM 150-6, the NM 150-7 transmits the write request to the NM 150-8. If the NM 150-8 receives the write request from the NM 150-7, the NM 150-8 stores the data into the NM first memory 152 of the NM 150-8.

The verification packet P1 and the response packet P2 are smaller in data size than the write request. Each of the NMs 150 has a storage area for storing data having the destination address, and each of the NMs 150 has a limited number of write requests that each of the NMs 150 accepts, in order to reserve an area for storing the verification packet P1 and the response packet P2 in the storage area. Thereby, even if congestion occurs in the communication network of the RCs 160, the NM 150 can transmit the verification packet P1 and the response packet P2 without delay.

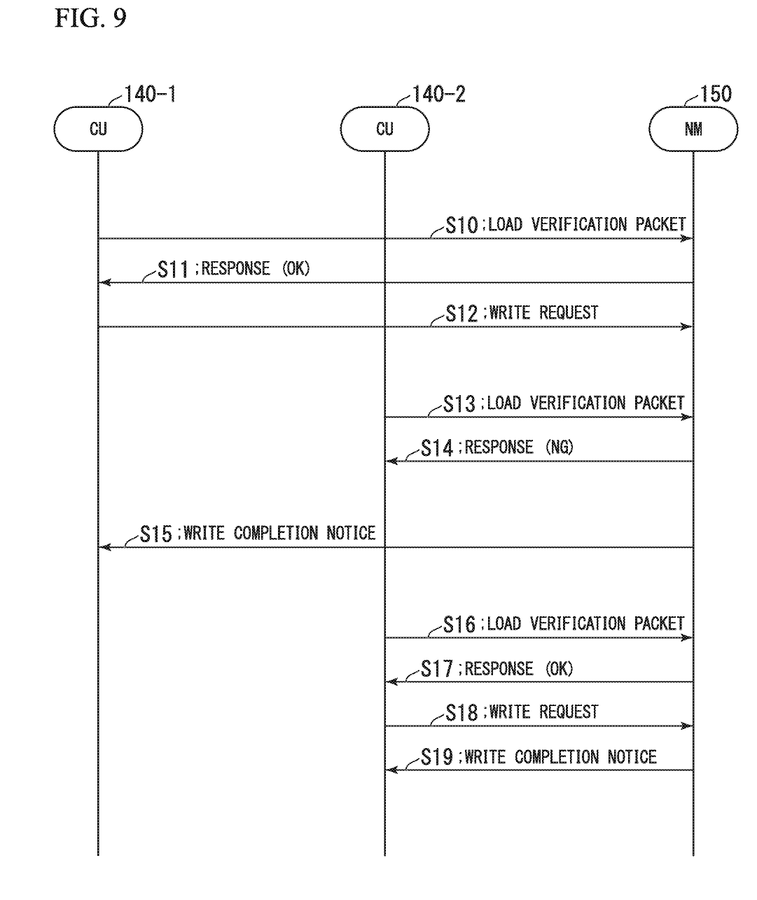

FIG. 9 is a sequence diagram illustrating operations of the CU and the NM (FPGA) according to the first embodiment. In FIG. 9, operations of the CU 140-1 and the CU 140-2 are shown on behalf of the CUs 140.

If the CU 140-1 receives a write command for writing data from the client 200, the CU 140-1 transmits a verification packet P1 to the NM 150 which is a destination of the data (step S10). If the NM 150 receives the verification packet P1 from the CU 140-1, the NM 150 determines whether or not the number of write requests, which are stored in the NM second memory 153 of the NM 150, is less than the reference value (whether or not the load of the NM 150 is less than the reference value).

If the NM 150 determines that the number of write requests, which are stored in the NM second memory 153 of the NM 150, is less than the reference value, the NM 150 generates the response packet P2 which indicates that the write request is accepted (OK). Thereafter, the NM 150 transmits the generated response packet P2 to the CU 140-1 (step S11).

If the CU 140-1 receives the response packet P2 which indicates that the write request is accepted (OK), from the NM 150, the CU 140-1 generates a write request for instructing the NM 150 to write the data. Thereafter, the CU 140-1 transmits the generated write request to the NM 150 via the communication network of the RCs 160 (step S12). The NM 150 stores the write request, which is received from the CU 140-1, in the NM second memory 153 thereof, which functions as a temporary memory. And, the NM 150 writes the data into the NM first memory 152 thereof, which functions as a non-volatile memory, in accordance with the write request stored in the NM second memory 153.

On the other hand, if the CU 140-2 receives a write command for writing data from the client 200, the CU 140-2 transmits a verification packet P1 to the NM 150 which is a destination of the data (step S13). If the NM 150 receives the verification packet P1 from the CU 140-2, the NM 150 determines whether or not the number of requests stored in the NM second memory 153 of the NM 150 is less than the reference value (whether or not the load of the NM 150 is less than the reference value).

If the NM 150 determines that the number of write requests in the NM second memory 153 is equal to or greater than the reference value, the NM 150 generates the response packet P2 which indicates that the write request is not accepted (NG). Thereafter, the NM 150 transmits the generated response packet P2 to the CU 140-2 (step S14).

If the CU 140-2 receives the response packet P2 which indicates that the write request is not accepted (NG), from the NM 150, the CU 140-2 does not transmit, to the NM 150, a write request for instructing the NM 150 to write the data. Therefore, the CU 140-2 repeatedly transmits the verification packet P1 to the NM 150 until the CU 140-2 receives the response packet P2 which indicates that the write request is accepted (OK), from the NM 150.

If the NM 150 completes the data writing with respect to the write request received from the CU 140-1, the NM 150 transmits a write completion notice to the CU 140-1 (step S15). Thereafter, the NM 150 removes the write request of which data writing has been completed from the NM second memory 153.

On the other hand, the CU 140-2 transmits the verification packet P1 again to the NM 150 (step S16). If the NM 150 receives the verification packet P1 from the CU 140-2, the NM 150 determines whether or not the number of write requests in the NM second memory 153 is less than the reference value (whether or not the load of the NM 150 is less than the reference value).

If the NM 150 determines that the number write requests is less than the reference value, the NM 150 generates the response packet P2 which indicates that the write request is accepted (OK). Thereafter, the NM 150 transmits the generated response packet P2 to the CU 140-2 (step S17).

If the CU 140-2 receives the response packet P2 which indicates that the write request is accepted (OK) from the NM 150, the CU 140-2 generates a write request for instructing the NM 150 to write the data. Thereafter, the CU 140-2 transmits the generated write request to the NM 150 via the communication network of the RCs 160 (step S18). The NM 150 stores the write request received from the CU 140-2 in the NM second memory 153 thereof. Also, the NM 150 writes the data into the NM first memory 152 thereof, in accordance with the write request stored in the NM second memory 153.

If the NM 150 completes the data writing with respect to the write request received from the CU 140-2, the NM 150 transmits a write completion notice to the CU 140-2 (step S19). Thereafter, the NM 150 removes the write request of which data writing has been completed from the NM second memory 153.

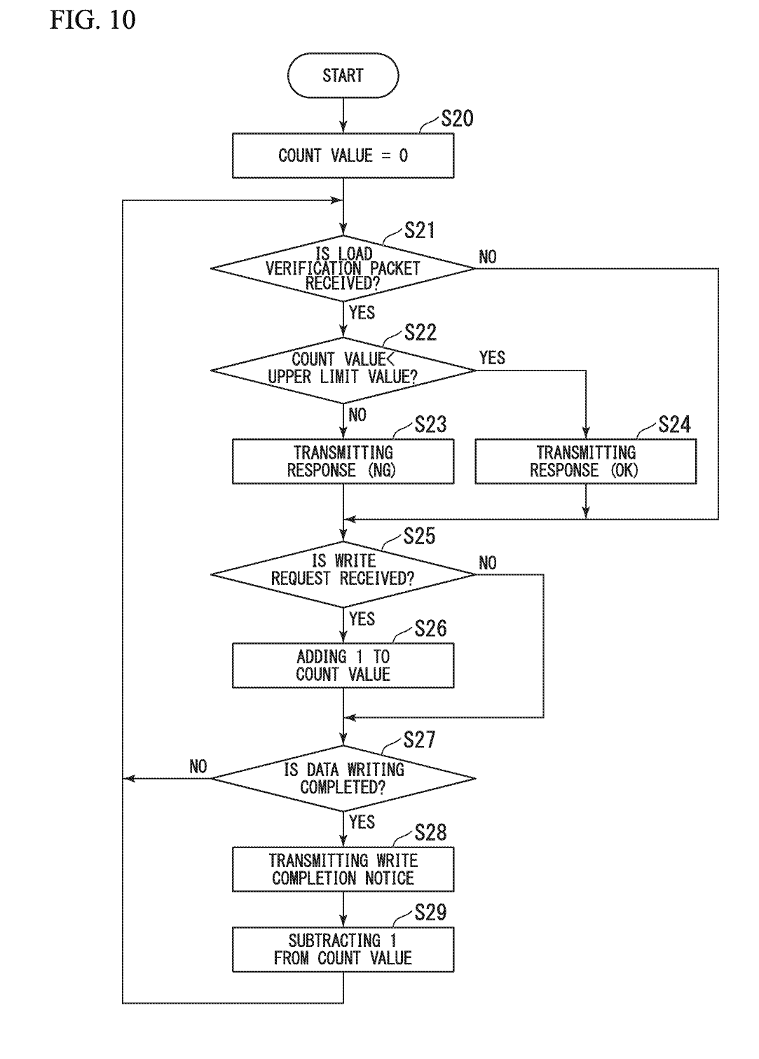

FIG. 10 is a flowchart illustrating an operation of the NM (FPGA) according to the first embodiment. The NM 150 initializes a count value to 0 (step S20). The count value indicates the number of write requests stored in the NM second memory 153. Next, the NM 150 determines whether or not the NM 150 receives a verification packet P1 from a CU 140 (step S21). If the NM 150 determines that the NM 150 does not receive the verification packet P1 from the CU 140, the process proceeds to the step S25. If the NM 150 determines that the NM 150 receives the verification packet P1 from the CU 140, the NM 150 determines whether or not the count value is less than an upper limit value (whether or not the load of the NM 150 is less than the reference value) (step S22).

If the NM 150 determines that the count value is not less than the upper limit value (No in step S22), the NM 150 generates the response packet P2 which indicates that the write request is not accepted (NG). Thereafter, the NM 150 transmits the generated response packet P2 to the CU 140 (step S23). On the other hand, if the NM 150 determines that the count value is less than the upper limit value, the NM 150 generates the response packet P2 which indicates that the write request is accepted (OK). Thereafter, the NM 150 transmits the generated response packet P2 to the CU 140 (step S24).

Thereafter, the NM 150 determines whether or not the NM 150 receives the write request from the CU 140 (step S25). If the NM 150 determines that the NM 150 does not receive the write request from the CU 140 (No in step S25), the process proceeds to the step S27. If the NM 150 determines that the NM 150 receives the write request from the CU 140 (Yes in step S25), the NM 150 adds 1 to the count value (step S26). The NM 150 stores the write request, which is received from the CU 140, in the NM second memory 153 which functions as a temporary memory. Also, the NM 150 writes the data into the NM first memory 152 which functions as a non-volatile memory, in accordance with the write request stored in the NM second memory 153.

Thereafter, the NM 150 determines whether or not the NM 150 completes the data writing to the NM first memory 152 (step S27). If the NM 150 determines that the NM 150 does not complete the data writing to the NM first memory 152 (No in step S27), the process returns to step S21. On the other hand, if the NM 150 determines that the NM 150 completes the data writing to the NM first memory 152 (Yes in step S27), the NM 150 transmits the write completion notice to the CU 140 (step S28). Next, the NM 150 removes the write request of which data writing has been completed from the NM second memory 153, and the NM 150 subtracts 1 from the count value (step S29). Thereafter, the process returns to step S21.

As described above, in the first embodiment, the CU 140 verifies that a load of the NM 150 is less than the reference value, and the CU 140 generates a write request for writing the data into the NM first memory 152 of the NM 150. Specifically, the CU 140 generates the verification packet P1 for verifying the load of the NM 150. The NM 150 receives the verification packet P1, and generates a response packet P2 to the verification packet P1. The CU 140 generates the write request in response to the response packet (OK) P2 accepting the request. Thereby, writing performance of the storage system 100 may not be compromised.

### Second Embodiment

In the first embodiment, the CU 140 verifies that the load of the NM 150 of the write destination is less than the reference value, and transmits the write request to the NM 150. In contrast, in a second embodiment, the NM 150 performs a data write reservation, and the NM 150 transmits, to the CU 140, information indicating whether or not the reservation is accepted. Only if the reservation is accepted, the CU 140 transmits a write reservation to the NM 150. The “reservation” in the second embodiment means sequential operations in which the CU 140 transmits a reservation packet to the NM 150 and the CU 140 receives a reservation completion notice. The second embodiment is described below in detail.

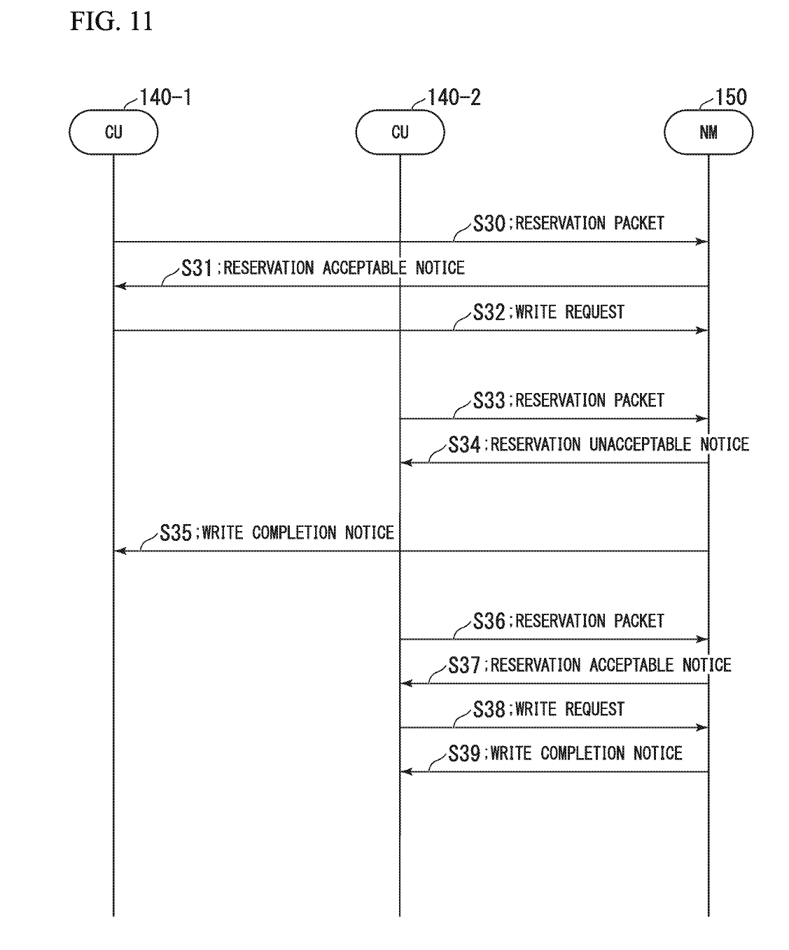

FIG. 11 is a sequence diagram illustrating operations of the CU and the NM (FPGA) according to the second embodiment. In FIG. 11, operations of the CU 140-1 and the CU 140-2 are shown on behalf of the CUs 140.

If the CU 140-1 receives a write command for writing data from the client 200, the CU 140-1 transmits a reservation packet P3 to the NM 150 (step S30). The reservation packet P3 contains the content shown in FIG. 6. For example, a source address and a destination address are described in the header area HA of the reservation packet P3. For example, data indicating that this packet is a reservation packet is described in the payload area PA of the reservation packet P3. For example, a CRC code is described in the redundant area RA of the reservation packet P3.

The reservation packet P3 is smaller in data size than the write request. The NM 150 limits a number of write requests that can be stored in a storage area of the NM second memory 153, in order to reserve an area for storing the reservation packet P3 in the storage area. Thereby, even if congestion occurs in the communication network of the RCs 160, the NM 150 can transmit the reservation packet P3 without delay.

If the NM 150 receives the reservation packet P3 from the CU 140-1, the NM 150 determines whether or not the number of data write reservations is less than a reference value. If the NM 150 determines that the number of data write reservations is less than the reference value, the NM 150 transmits a reservation completion notice to the CU 140-1, and the NM 150 adds 1 to a count value which indicates the number of data write reservations (step S31).

If the CU 140-1 receives the reservation completion notice from the NM 150, the CU 140-1 generates a write request for instructing the NM 150 to write the data. Thereafter, the CU 140-1 transmits the generated write request to the NM 150 via the communication network of the RCs 160 (step S32). The NM 150 stores the write request received from the CU 140-1 in the NM second memory 153, which functions as a temporary memory. And, the NM 150 writes the data into the NM first memory 152 which functions as a non-volatile memory, in accordance with the write request stored in the NM second memory 153.

On the other hand, if the CU 140-2 receives a write command for writing data from the client 200, the CU 140-2 transmits the reservation packet P3 to the NM 150 which is a destination of the data (step S33). If the NM 150 receives the reservation packet P3 from the CU 140-2, the NM 150 determines whether or not the number of data write reservations is less than the reference value. If the NM 150 determines that the number of data write reservations is equal to or more than the reference value, the NM 150 transmits a reservation unacceptable notice to the CU 140-2 (step S34). The reservation unacceptable notice indicates that the reservation is not accepted.

If the CU 140-2 receives the reservation unacceptable notice from the NM 150, the CU 140-2 does not transmit the write request to the NM 150. Instead, the CU 140-2 repeatedly transmits the reservation packet P3 to the NM 150 until the CU 140-2 receives the reservation completion notice from the NM 150.

If the NM 150 completes the data writing corresponding to the write request which is received from the CU 140-1, the NM 150 transmits a write completion notice to the CU 140-1 (step S35). Thereafter, the NM 150 removes the write request of which data writing has been completed from the NM second memory 153. Also, the NM 150 subtracts 1 from the count value which indicates the number of data write reservations.

On the other hand, the CU 140-2 transmits the reservation packet P3 again to the NM 150 (step S36). If the NM 150 receives the reservation packet P3 from the CU 140-2, the NM 150 determines whether or not the number of data write reservations is less than the reference value. If the NM 150 determines that the number of data write reservations is less than the reference value, the NM 150 transmits the reservation completion notice to the CU 140-2, and the NM 150 adds 1 to the count value which indicates the number of data write reservations (step S37).

If the CU 140-2 receives the reservation completion notice from the NM 150, the CU 140-2 generates a write request for instructing the NM 150 to write data. Thereafter, the CU 140-2 transmits the generated write request to the NM 150 via the communication network of the RCs 160 (step S38). The NM 150 stores the write request received from the CU 140-2 in the NM second memory 153. And, the NM 150 writes the data into the NM first memory 152, in accordance with the write request which is stored in the NM second memory 153.

If the NM 150 completes the data writing corresponding to the write request received from the CU 140-2, the NM 150 transmits a write completion notice to the CU 140-2 (step S39). Thereafter, the NM 150 removes the write request of which data writing has been completed from the NM second memory 153. Also, the NM 150 subtracts 1 from the count value which indicates the number of data write reservations.

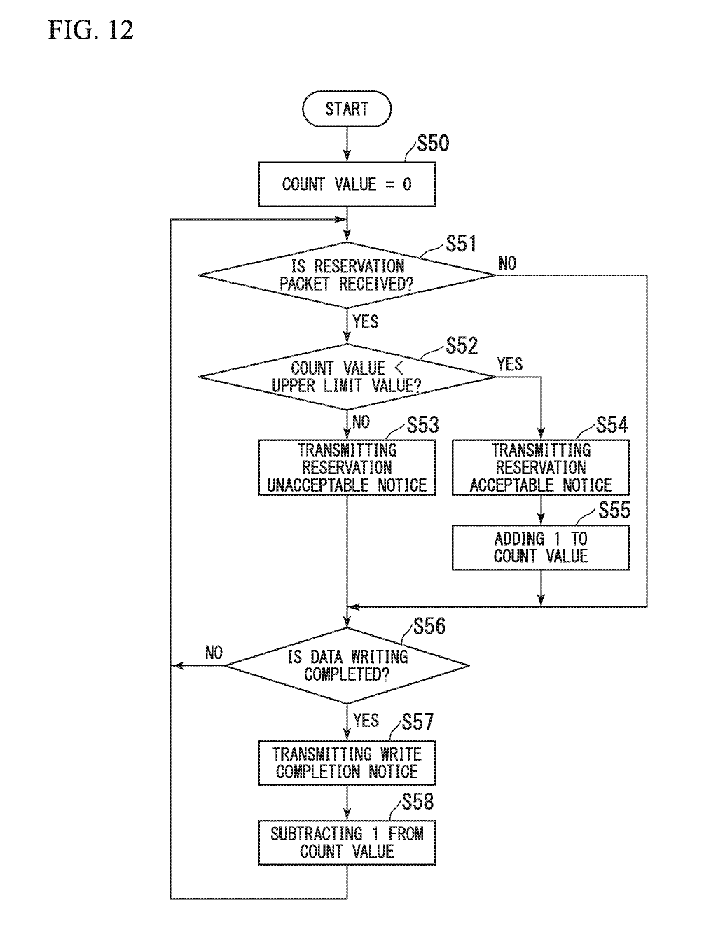

FIG. 12 is a flowchart illustrating an operation of the NM (FPGA) according to the second embodiment. The NM 150 initializes a count value to 0 (step S50). The count value indicates the number of reservations of write requests. Next, the NM 150 determines whether or not the NM 150 receives the reservation packet P3 from a CU 140 (step S51). If the NM 150 determines that the NM 150 does not receive the reservation packet P3 from the CU 140 (No in step S51), the process proceeds to the step S56. In the step S51, if the NM 150 determines that the NM 150 receives the reservation packet P3 from the CU 140 (Yes in step S51), the NM 150 determines whether or not the count value is less than an upper limit value (whether or not the number of write reservations is less than the reference value) (step S52).

If the NM 150 determines that the count value is not less than the upper limit value (No in step S52), the NM 150 transmits the reservation unacceptable notice to the CU 140 (step S53). On the other hand, if the NM 150 determines that the count value is less than the upper limit value (Yes in step S53), the NM 150 transmits the reservation completion notice to the CU 140 (step S54). Thereafter, the NM 150 adds 1 to the count value (step S55).

If the CU 140 receives the reservation completion notice from the NM 150, the CU 140 generates a write request for instructing the NM 150 to write the data. Thereafter, the CU 140 transmits the generated write request to the NM 150 via the communication network of the RCs 160. The NM 150 stores the write request received from the CU 140 in the NM second memory 153. Also, the NM 150 writes the data into the NM first memory 152, in accordance with the write request stored in the NM second memory 153.

Thereafter, the NM 150 determines whether or not the NM 150 completes the data writing to the NM first memory 152 (step S56). If the NM 150 determines that the NM 150 does not complete the data writing to the NM first memory 152 (No in step S56), the process returns to step S51. On the other hand, if the NM 150 determines that the NM 150 has completed the data writing to the NM first memory 152, the NM 150 transmits the write completion notice to the CU 140 (step S57). Next, the NM 150 removes the write request of which data writing has been completed from the NM second memory 153, and the NM 150 subtracts 1 from the count value (step S58). Thereafter, the process returns to step S51.

As described above, in the second embodiment, the CU 140 performs a write reservation of data with respect to the NM 150, and then generates a write request for writing the data into the NM first memory 152 of the NM 150. Specifically, the CU 140 generates a reservation packet P3, and the NM 150 determines whether or not the write reservation based on the reservation packet P3 is acceptable. The NM 150 generates a reservation acceptable notice, if the NM 150 determines that the write reservation is acceptable. The CU 140 generates a write request based on the reservation acceptable notice. The NM 150 generates a reservation unacceptable notice, if the NM 150 determines that the write reservation is unacceptable. The CU 140 re-generates a reservation packet based on the reservation unacceptable notice. Thereby, a writing performance of the storage system 100 may not be compromised.

In the second embodiment, the CU 140 may generate a reservation packet P3 for write reservation with respect to the NM 150, when the CU 140 verifies that the load of the NM 150 is less than the reference value. Thereby, the load of the NM 150 will not increase after the load is verified and before the write request is performed. Also, the number of write requests issued by the CUs 140 will not exceed the upper limit. Therefore, congestion will not occur in a communication path from the CU 140 to the NM 150, and the writing performance of the storage system 100 may not be compromised.

### Third Embodiment

In a first embodiment, the CU 140 transmits the verification packet P1 to the NM 150. In the second embodiment, the CU 140 transmits the reservation packet P3 to the NM 150. In a third embodiment, the CU 140 does not transmit the verification packet P1 to the NM 150, but transmits the reservation packet P3 to the NM 150, and the NM 150 stores a reservation list for managing a reservation of write requests in the NM second memory 153. The “reservation” in the third embodiment means sequential operations in which the CU 140 transmits a reservation packet P3 to the NM 150 and the NM 150 registers a reservation of a write request with the reservation list. The third embodiment is described below in detail.

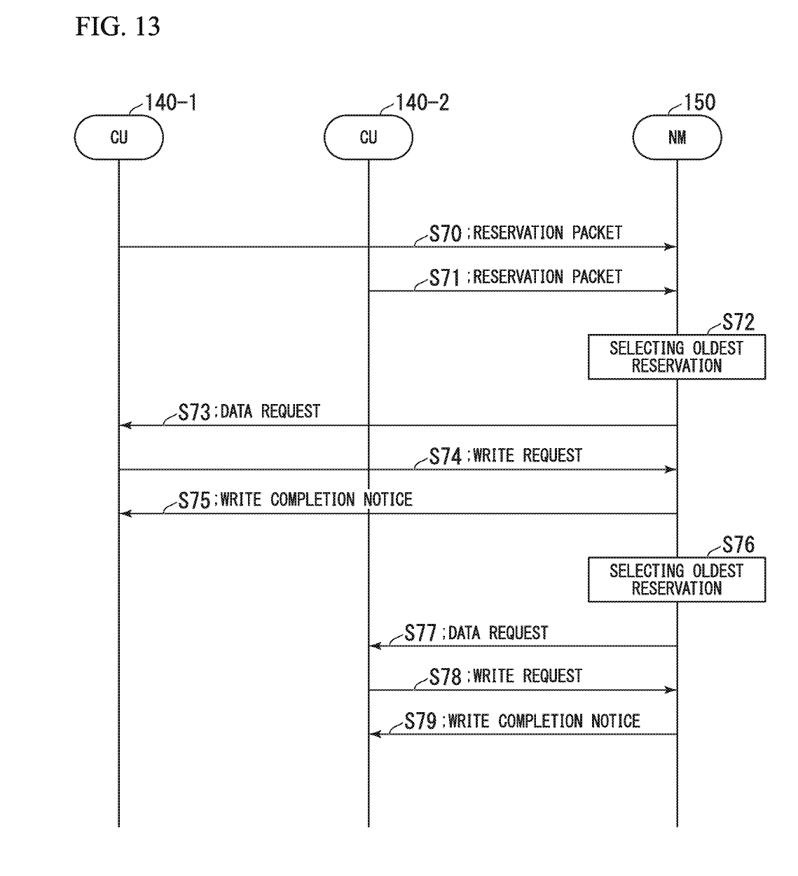

FIG. 13 is a sequence diagram illustrating operations of the CU and the NM (FPGA) according to the third embodiment. In FIG. 13, operations of the CU 140-1 and the CU 140-2 are shown on behalf of the CUs 140.

If the CU 140-1 receives a write command for writing data from the client 200, the CU 140-1 transmits a reservation packet P3 to the NM 150 which is a write destination (step S70). The NM 150 updates the reservation list stored in the NM second memory 153 in accordance with the reservation packet P3 from the CU 140-1. Specifically, the NM 150 registers, in the reservation list, the reservation of the write request corresponding to the received reservation packet P3.

If the CU 140-2 receives a write command for writing data from the client 200, the CU 140-2 transmits a reservation packet P3 to the NM 150 which is a write destination (step S71). The NM 150 updates the reservation list stored in the NM second memory 153 in accordance with the reservation packet P3 from the CU 140-2. Specifically, the NM 150 registers, in the reservation list, the reservation of the write request corresponding to the received reservation packet P3.

The NM 150 selects the oldest reservation (reservation of the CU 140-1) in the reservation list in the NM second memory 153 (step S72). Thereafter, the NM 150 transmits a data request to the CU 140-1 which is a source of the selected reservation (step S73).

If the CU 140-1 receives the data request from the NM 150, the CU 140-1 generates a write request for instructing the NM 150 to write data. Thereafter, the CU 140-1 transmits the generated write request to the NM 150 via the communication network of the RCs 160 (step S74). The NM 150 stores the write request from the CU 140-1 in the NM second memory 153 which functions as a temporary memory. Also, the NM 150 writes the data into the NM first memory 152 which functions as a non-volatile memory, in accordance with the write request stored in the NM second memory 153.

If the NM 150 completes the data writing corresponding to the write request from the CU 140-1, the NM 150 transmits a write completion notice to the CU 140-1 (step S75). Thereafter, the NM 150 removes the write request of which data writing has been completed from the NM second memory 153. Also, the NM 150 removes the reservation of the CU 140-1 from the reservation list.

Next, the NM 150 selects the oldest reservation (reservation of the CU 140-2) in the reservation list in the NM second memory 153 (step S76). Thereafter, the NM 150 transmits a data request to the CU 140-2 which is a source of the selected reservation (step S77).

If the CU 140-2 receives the data request from the NM 150, the CU 140-2 generates a write request for instructing the NM 150 to write data. Thereafter, the CU 140-2 transmits the generated write request to the NM 150 via the communication network of the RCs 160 (step S78). The NM 150 stores the write request from the CU 140-2 in the NM second memory 153. Also, the NM 150 writes the data into the NM first memory 152, in accordance with the write request stored in the NM second memory 153.

If the NM 150 completes the data writing corresponding to the write request from the CU 140-2, the NM 150 transmits a write completion notice to the CU 140-2 (step S79). Thereafter, the NM 150 removes the write request of which data writing has been completed from the NM second memory 153. Also, the NM 150 removes the reservation of the CU 140-2 from the reservation list.

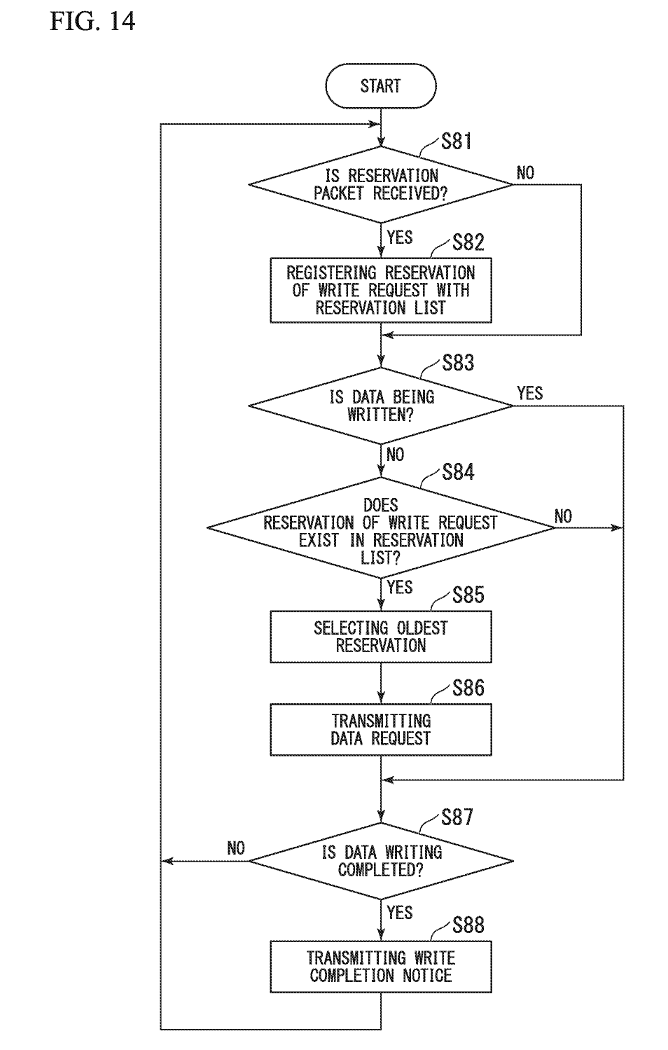

FIG. 14 is a flowchart illustrating an operation of the NM (FPGA) according to the third embodiment. The NM 150 determines whether or not the NM 150 receives the reservation packet P3 from the CU 140 (step S81). If the NM 150 determines that the NM 150 does not receive the reservation packet P3 from the CU 140, the process proceeds to the step S83 described below. If the NM 150 determines that the NM 150 received the reservation packet P3 from the CU 140 (Yes in step S81), the NM 150 registers, in the reservation list, a reservation of a write request corresponding to the received reservation packet P3 (step S82).

Next, the NM 150 determines whether or not data are being written into the NM first memory 152 (step S83). If the NM 150 determines that data are being written, the process proceeds to step S87.

If the NM 150 determines that data are not being written (No in step S83), the NM 150 determines whether or not any reservation of a write request exists in the reservation list (step S84). If the NM 150 determines that any reservation of a write request does not exist in the reservation list, the process proceeds to step S87.

If the NM 150 determines that a reservation of a write request exists in the reservation list, the NM 150 selects the oldest reservation in the reservation list (step S85). Then, the NM 150 transmits a data request to the CU 140 which is a source of the selected reservation (step S86).

Thereafter, the NM 150 determines whether or not the NM 150 completes the data writing to the NM first memory 152 (step S87). If the NM 150 determines that the NM 150 does not complete the data writing to the NM first memory 152 (No in step S87), the process returns to step S81. On the other hand, if the NM 150 determines that the NM 150 completes the data writing to the NM first memory 152 (Yes in step S87), the NM 150 transmits the write completion notice to the CU 140 (step S88).

Next, the NM 150 removes the write request of which data writing has been completed from the NM second memory 153. Also, the NM 150 removes the reservation of which data writing has been completed from the reservation list. Thereafter, the process returns to step S81.

As described above, according to the third embodiment, the CU 140 performs a write reservation of the data with respect to the NM 150, and then generates the write request to the NM 150. Specifically, the CU 140 generates a reservation packet P3 for write reservation with respect to the NM 150. The NM 150 receives the reservation packet P3 from the CU 140. The NM 150 selects the oldest reservation based on the reservation packets P3 received from the CU 140. The NM 150 writes data associated with the oldest reservation, into the NM first memory 152 of the NM 150. The NM 150 has a reservation list for managing reservation of write requests. The NM 150 updates the reservation list in accordance with the reservation packet P3 which is transmitted from the CU 140. Thereby, the writing performance of the storage system 100 may not be compromised.

In the second embodiment, if a reservation exceeds a writing performance of the NM 150, the reservation is not accepted. However, in the third embodiment, because the NM 150 transfers a data request to a next CU 140 in accordance with the reservation list, more reservations can be accepted.

### Fourth Embodiment

In the third embodiment, if the CU 140 receives the data request from the NM 150, the CU 140 transmits the write request to the NM 150. In contrast, in a fourth embodiment, if the CU 140 receives a right transfer notice from another CU 140, the CU 140 transmits a write request to NM 150. The fourth embodiment is described below in detail.

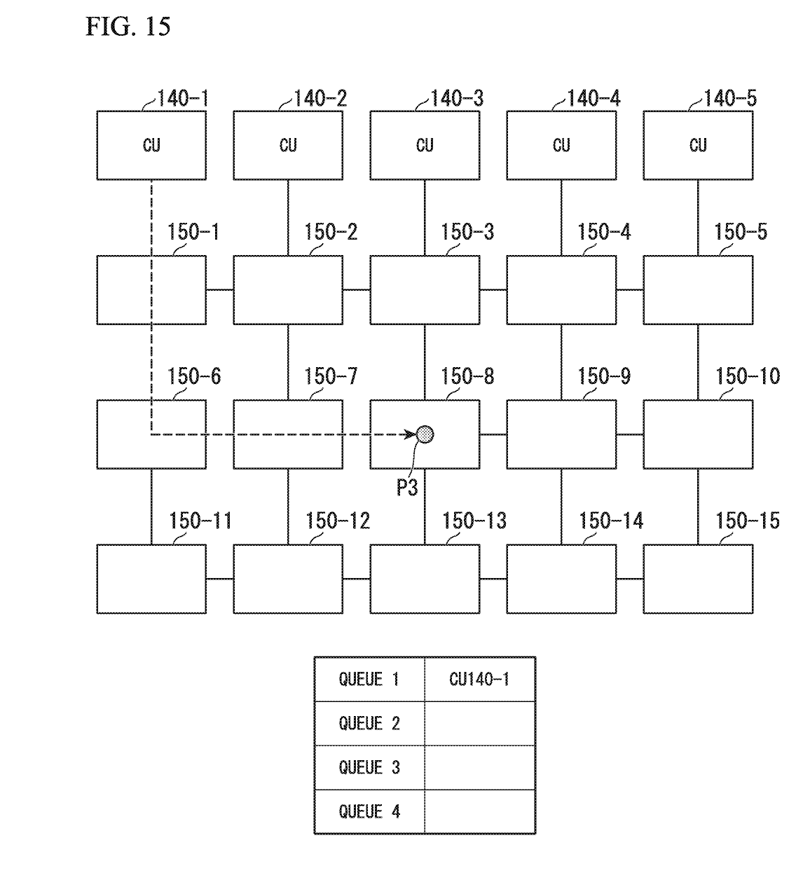

FIG. 15 to FIG. 20 illustrate a data transmission operation of the CU and the NM (FPGA) according to the fourth embodiment. The NM second memory 153 of the NM 150-8 stores queues 1 to 4. Reservation data received from the CU 140 are stored in the queues 1 to 4. The reservation data are data for identifying a CU 140 of a source of a reservation packet. The oldest reservation data are stored in the queue 1.

As shown in FIG. 15, if the CU 140-1 is to transmit a write request to the NM 150-8, the CU 140-1 transmits, prior to the write request, a reservation packet P3, which is for reserving data writing, to the NM 150-8. If the NM 150-8 receives the reservation packet P3 from the CU 140-1, the NM 150-8 stores the reservation data of the CU 140-1 in the queue 1.

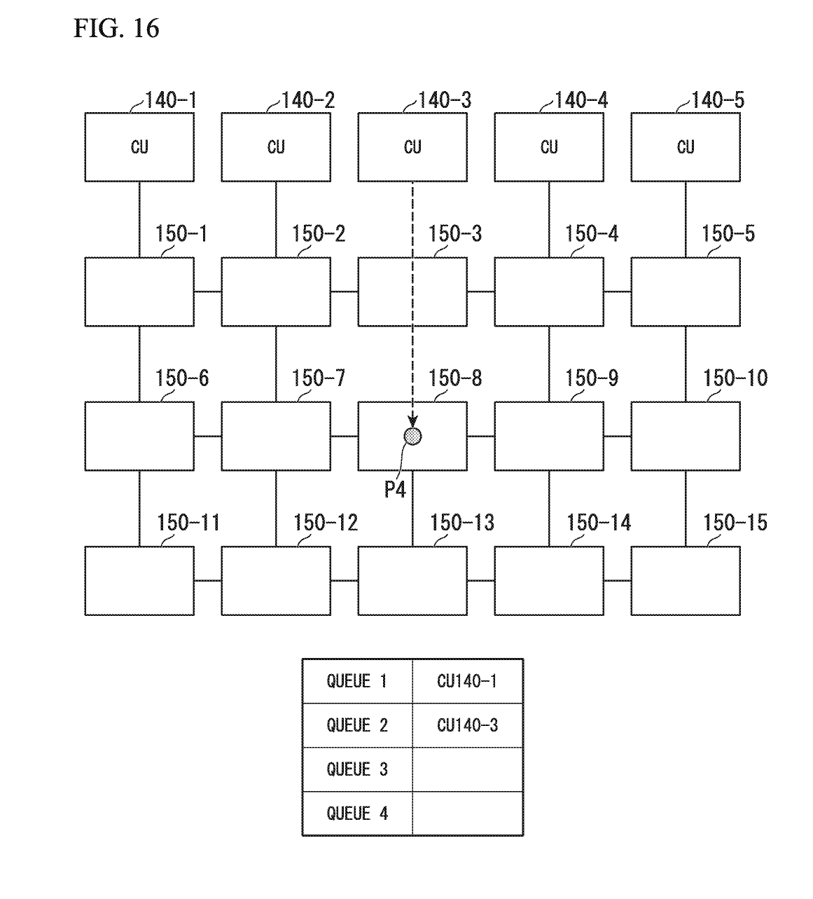

On the other hand, as shown in FIG. 16, if the CU 140-3 is to transmit a write request to the NM 150-8, the CU 140-3 transmits, prior to the write request, a reservation packet P4, which is for reserving data writing, to the NM 150-8. If the NM 150-8 receives the reservation packet P4 from the CU 140-3, the NM 150-8 stores the reservation data of the CU 140-3 in the queue 2.

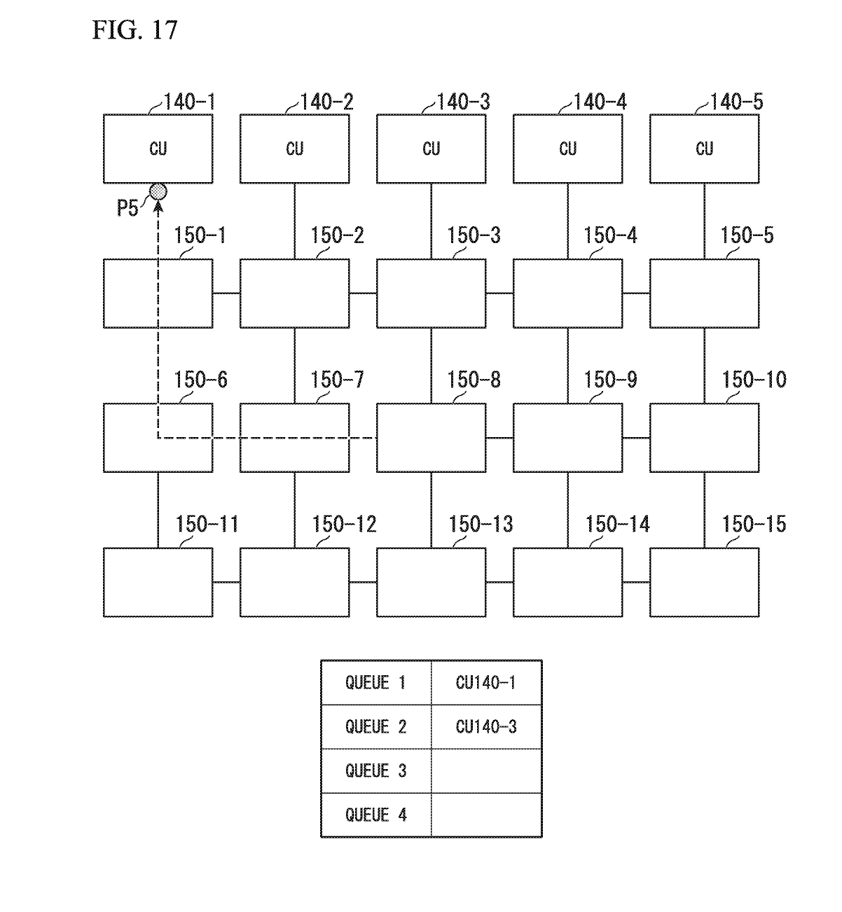

As shown in FIG. 17, the NM 150-8 transmits a data request packet P5 to the CU 140-1 which corresponds to the reservation data stored in the queue 1. If the CU 140-1 receives the data request packet P5 from the NM 150-8, the CU 140-1 generates a write request W2 for instructing the NM 150-8 to write data.

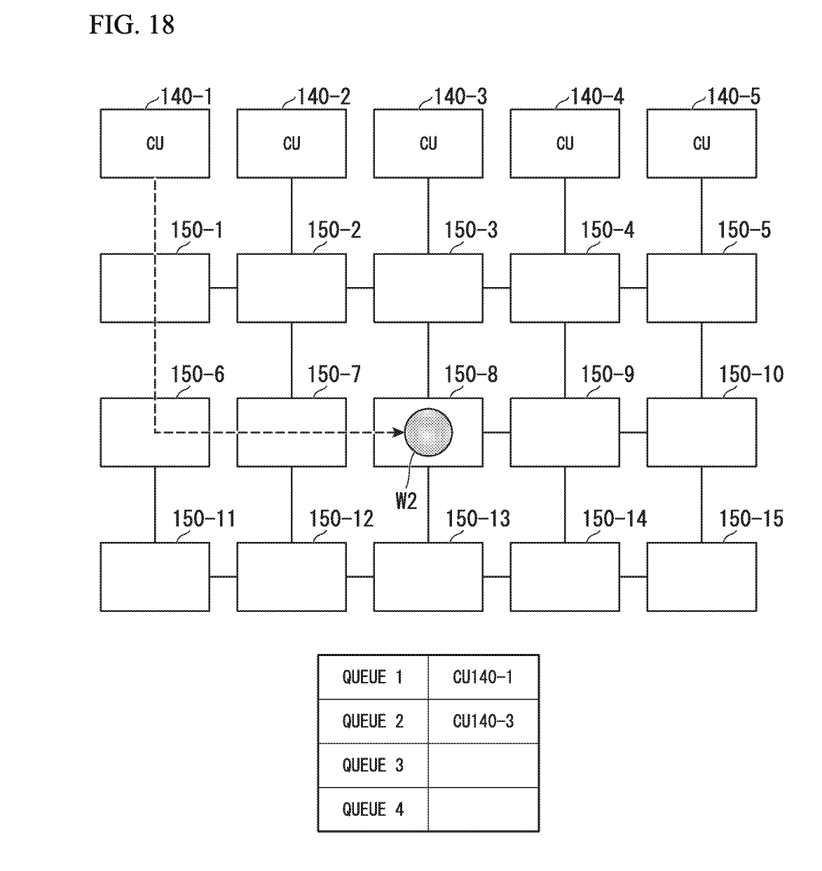

As shown in FIG. 18, the CU 140-1 transmits the generated write request W2 to the NM 150-8 via the communication network of the RCs 160. The NM 150-8 stores the write request W2 received from the CU 140-1, in the NM second memory 153 which functions as a temporary memory. Thereafter, the NM 150-8 writes the data into the NM first memory 152 which functions as a non-volatile memory, in accordance with the write request W2 stored in the NM second memory 153.

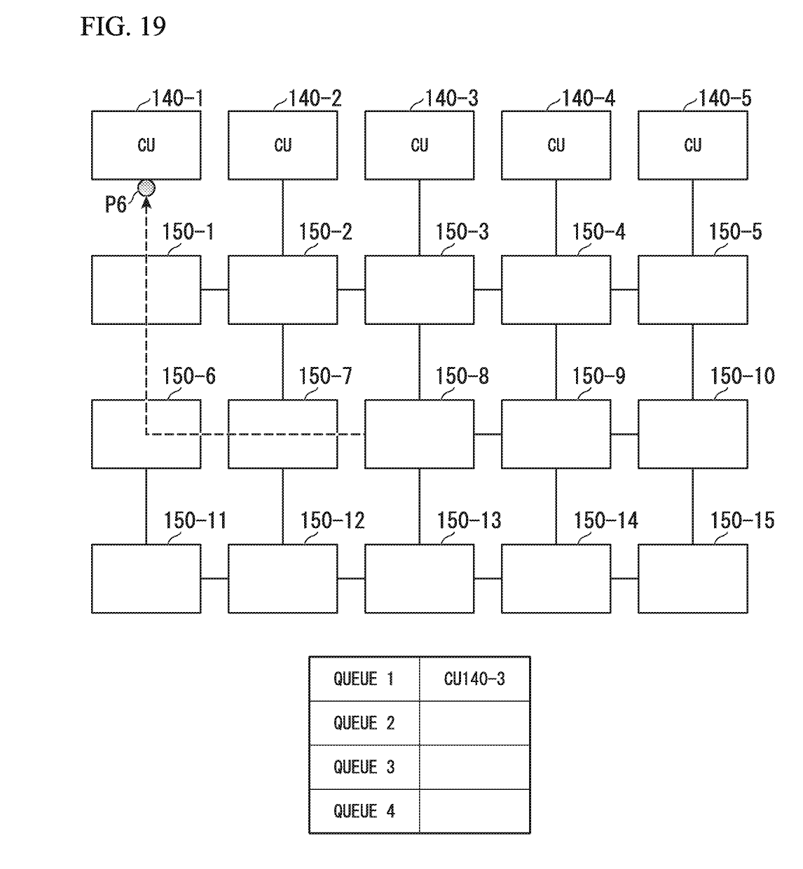

As shown in FIG. 19, if the NM 150-8 completes the execution of the write request W2 received from the CU 140-1, the NM 150-8 transmits a write completion notice P6 and identification information to the CU 140-1. The identification information is information for identifying the CU 140-3 which is a source of a write request to be executed next. The NM 150-8 may describe, in the payload area PA of the write completion notice P6, the identification information of the CU 140-3.

Thereafter, the NM 150-8 removes the write request of which data writing has been completed from the NM second memory 153. Also, the NM 150-8 transfers the reservation data of the CU 140-3 stored in the queue 2 to the queue 1.

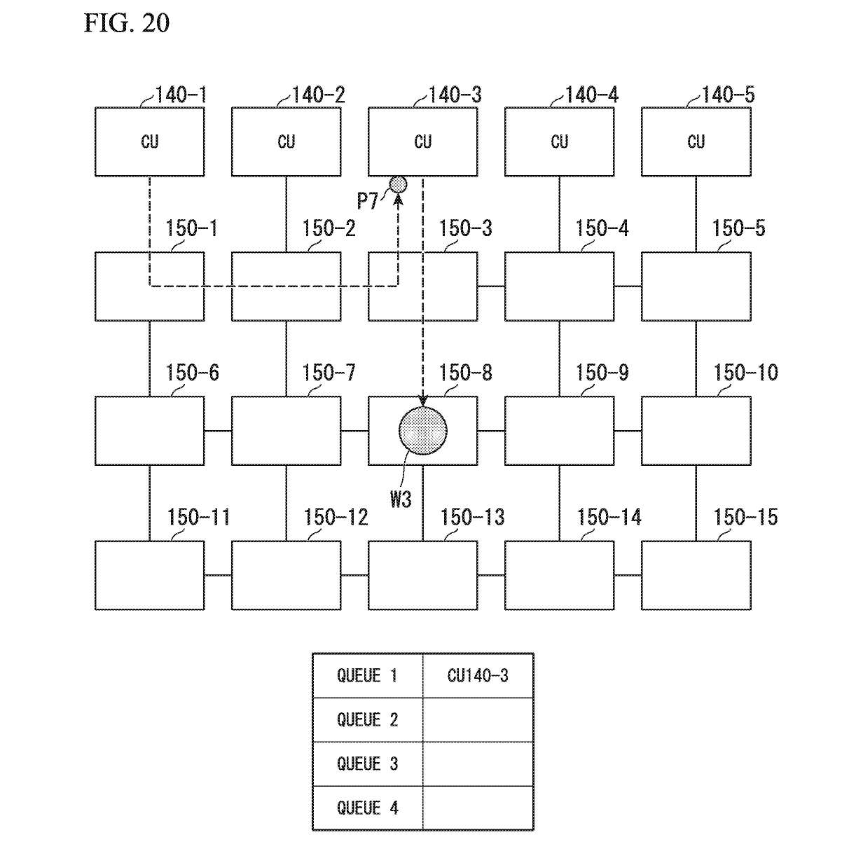

As shown in FIG. 20, if the CU 140-1 receives the write completion notice P6 and the identification information from the NM 150-8, the CU 140-1 transmits a right transfer notice P7 to the CU 140-3 which corresponds to the received identification information. The right transfer notice P7 is a notice which indicates that a right of transmitting a write request is transferred. In this way, because the CU 140-1 transmits the right transfer notice P7 to the CU 140-3, it is not necessary for the NM 150-8 to transmit a data request to the CU 140-3. Therefore, a load of the NM 150-8 can be reduced.

If the CU 140-3 receives the right transfer notice P7 from the CU 140-1, the CU 140-3 generates a write request W3 for instructing the NM 150-8 to write data. Thereafter, the CU 140-3 transmits the generated write request W3 to the NM 150-8 via the communication network of the RCs 160. The NM 150-8 stores the write request W3 received from the CU 140-3 in the NM second memory 153. Also, the NM 150-8 writes the data into the NM first memory 152, in accordance with the write request W3 stored in the NM second memory 153.

Thereafter, the NM 150-8 removes the write request of which data writing has been completed from the NM second memory 153. Also, the NM 150-8 removes the reservation data of the CU 140-3 from the queue 1.

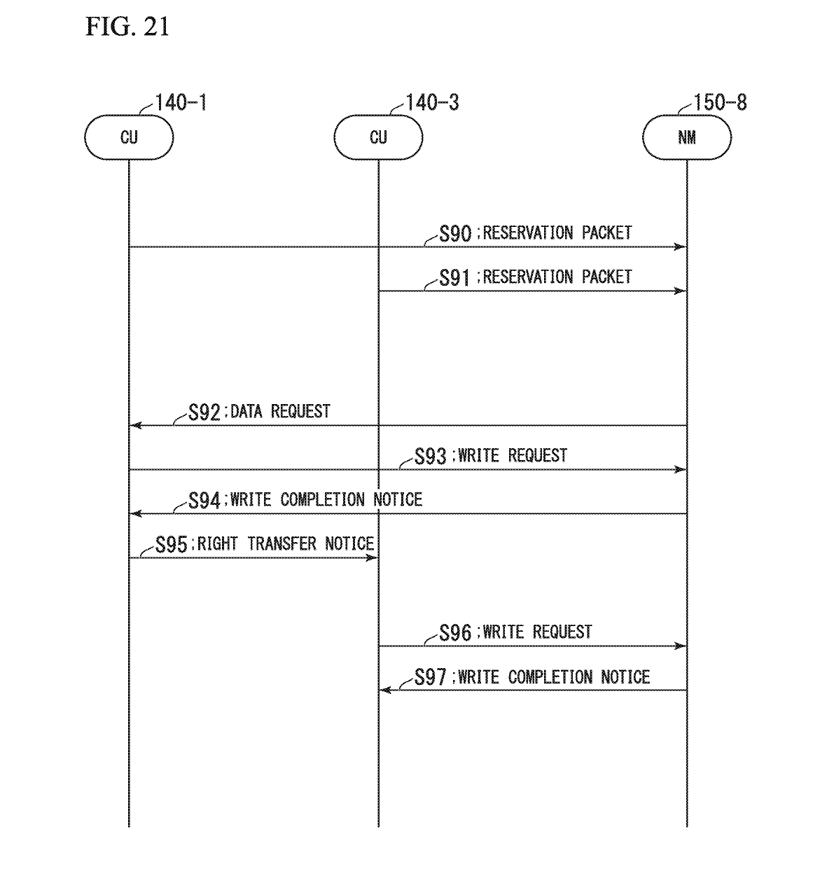

FIG. 21 is a sequence diagram illustrating operations of the CU and the NM (FPGA) according to the fourth embodiment. In FIG. 21, operations of the CU 140-1 and the CU 140-2 are shown on behalf of the CUs 140. Also, an operation of the NM 150-8 is shown on behalf of the NMs 150.

If the CU 140-1 receives a write command for writing data from the client 200, the CU 140-1 transmits a reservation packet P3 to the NM 150-8 which is a write destination (step S90). If the NM 150-8 receives the reservation packet P3 from the CU 140-1, the NM 150-8 stores a reservation data of the CU 140-1 in the queue 1.

If the CU 140-3 receives a write command for writing data from the client 200, the CU 140-3 transmits a reservation packet P4 to the NM 150-8 which is a write destination (step S91). If the NM 150-8 receives the reservation packet P4 from the CU 140-3, the NM 150-8 stores a reservation data of the CU 140-3 in the queue 2.

Next, the NM 150-8 transmits a data request packet P5 to the CU 140-1 which corresponds to the reservation data stored in the queue 1 (step S92). If the CU 140-1 receives the data request packet P5 from the NM 150-8, the CU 140-1 generates a write request W2 for instructing the NM 150-8 to write data. Thereafter, the CU 140-1 transmits the generated write request W2 to the NM 150-8 via the communication network of the RCs 160 (step S93).

The NM 150-8 stores the write request W2 received from the CU 140-1 in the NM second memory 153. Also, the NM 150-8 writes the data into the NM first memory 152, in accordance with the write request W2 stored in the NM second memory 153.

If the NM 150-8 completes the data writing with respect to the write request W2 received from the CU 140-1, the NM 150-8 transmits a write completion notice P6 and an identification information of the CU 140-3 to the CU 140-1 (step S94). Thereafter, the NM 150-8 removes the write request W2 of which data writing has been completed from the NM second memory 153. Also, the NM 150-8 moves the reservation data of the CU 140-3 stored in the queue 2, to the queue 1.

If the CU 140-1 receives the write completion notice P6 and the identification information from the NM 150-8, the CU 140-1 transmits a right transfer notice P7 to the CU 140-3 corresponding to the received identification information (step S95).

If the CU 140-3 receives the right transfer notice P7 from the CU 140-1, the CU 140-3 generates a write request W3 for instructing the NM 150-8 to write data. Thereafter, the CU 140-3 transmits the generated write request W3 to the NM 150-8 via the communication network of the RCs 160 (step S96).

The NM 150-8 stores the write request W3 received from the CU 140-3, into the NM second memory 153. Also, the NM 150-8 writes the data in the NM first memory 152, in accordance with the write request W3 stored in the NM second memory 153. If the NM 150-8 completes the data writing with respect to the write request W3 from the CU 140-3, the NM 150-8 transmits a write completion notice to the CU 140-3 (step S97).

Thereafter, the NM 150-8 removes the write request of which data writing has been completed from the NM second memory 153. Also, the NM 150-8 removes the reservation data of the CU 140-3 from the queue 1.

As described above, according to the fourth embodiment, if an execution of the write request W2 is completed, the NM 150-8 transmits the write completion notice P6 and the identification information of the CU 140-3 to the CU 140-1. If the CU 140-1 receives the write completion notice P6 and the identification information from the NM 150-8, the CU 140-1 transmits the right transfer notice P7 to the CU 140-3 corresponding to the identification information. If the CU 140-3 receives the right transfer notice P7 from the CU 140-1, the CU 140-3 transmits the write request W3 to the NM 150-8. Thereby, the load of the NM 150-8 can be reduced, and the writing performance of the storage system 100 may not be compromised.

### Fifth Embodiment

In the first embodiment to the fourth embodiment, the CU 140 transmits the verification packet P1 or the reservation packet P3 to the NM 150. In contrast, in a fifth embodiment, the CU 140 transmits a congestion confirmation packet P8 to the NM 150. If the CU 140 receives a response to the congestion confirmation packet P8 from the NM 150, the CU 140 transmits a write request to the NM 150. The “congestion” in the fifth embodiment means a state in which a routing cannot be properly performed via the RC 160 because the PMU 180 is full of packets, and the NM 150 cannot properly transfer data (i.e., busy). The fifth embodiment is described below in detail.

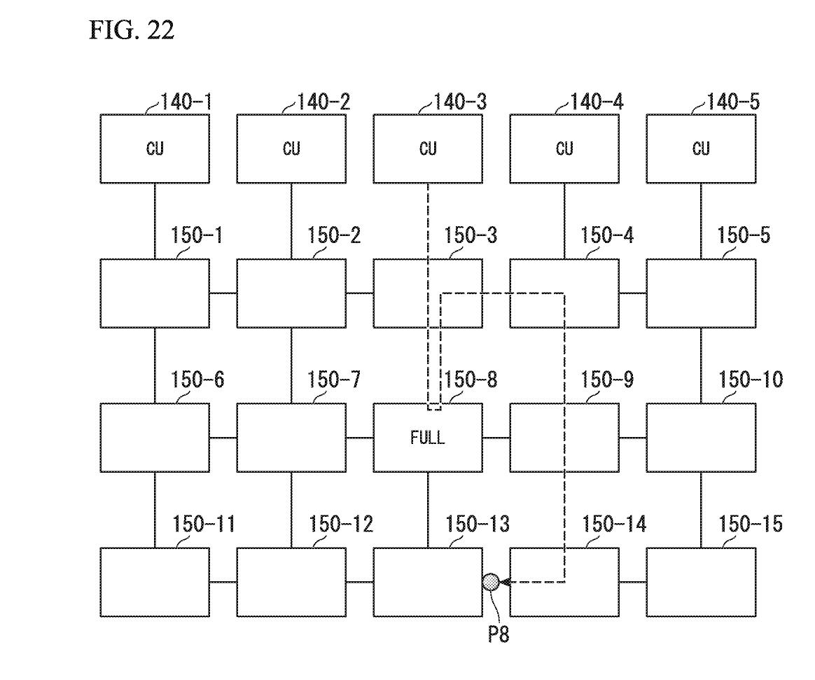

FIG. 22 to FIG. 24 illustrate a data transmission operation of the CU and the NM (FPGA) according to the fifth embodiment. As shown in FIG. 22, if the CU 140-3 is to transmit a write request to the NM 150-13, the CU 140-3 transmits a congestion confirmation packet P8 for confirming a congestion condition (busy state) to the NM 150-13 before transmitting the write request. The congestion confirmation packet P8 contains content shown in FIG. 6. For example, a source address and a destination address are described in the header area HA of the congestion confirmation packet P8. For example, data indicating that the packet is a congestion confirmation packet is described in the payload area PA of the congestion confirmation packet P8. For example, a CRC code is described in the redundant area RA of the congestion confirmation packet P8.

If the congestion confirmation packet P8 is to be transmitted to the NM 150-13 through the shortest route, the congestion confirmation packet P8 is transferred to NM 150-3, NM 150-8, and NM 150-13 in this order. However, for example, if the PMU 180 connected to the NM 150-8 is full of packets (in a case of PMU FULL state), any packet cannot pass through the communication path including the NM 150-8. Therefore, if the NM 150-8 receives the congestion confirmation packet P8 from the NM 150-3, the NM 150-8 adds information for identifying the NM 150-8, as congestion information, to the payload area PA of the congestion confirmation packet P8. Thereafter, the NM 150-8 returns the congestion confirmation packet P8 to the NM 150-3.

If the NM 150-3 receives the congestion confirmation packet P8 from the NM 150-8, the NM 150-3 refers to the congestion information of the congestion confirmation packet P8, and the NM 150-3 transmits the congestion confirmation packet P8 to a path which does not include the NM 150-8. For example, the NM 150-3 transmits the congestion confirmation packet P8 to the NM 150-4, the NM 150-4 transmits the congestion confirmation packet P8 to the NM 150-9, and the NM 150-9 transmits the congestion confirmation packet P8 to the NM 150-14. Thereafter, the NM 150-14 transmits the congestion confirmation packet P8 to the NM 150-13 which is a destination of the congestion confirmation packet P8.

If the NM 150-13 receives the congestion confirmation packet P8 from the NM 150-14, the NM 150-13 generates a response packet P9. The response packet P9 contains content shown in FIG. 6. For example, a source address and a destination address are described in the header area HA of the response packet P9. For example, data indicating that the packet is a response packet and the congestion information included in the congestion confirmation packet P8 are described in the payload area PA of the response packet P9. For example, a CRC code is described in the redundant area RA of the response packet P9.

The congestion confirmation packet P8 and the response packet P9 are smaller in data size than the write request W4. The NM 150 may limit the number of the write requests that can be stored in the NM second memory 153, in order to reserve an area for storing the congestion confirmation packet P8 and the response packet P9 in the storage area. Thereby, even if congestion occurs in the communication network of the RCs 160, the NM 150 can transmit the congestion confirmation packet P8 and the response packet P9 without delay.

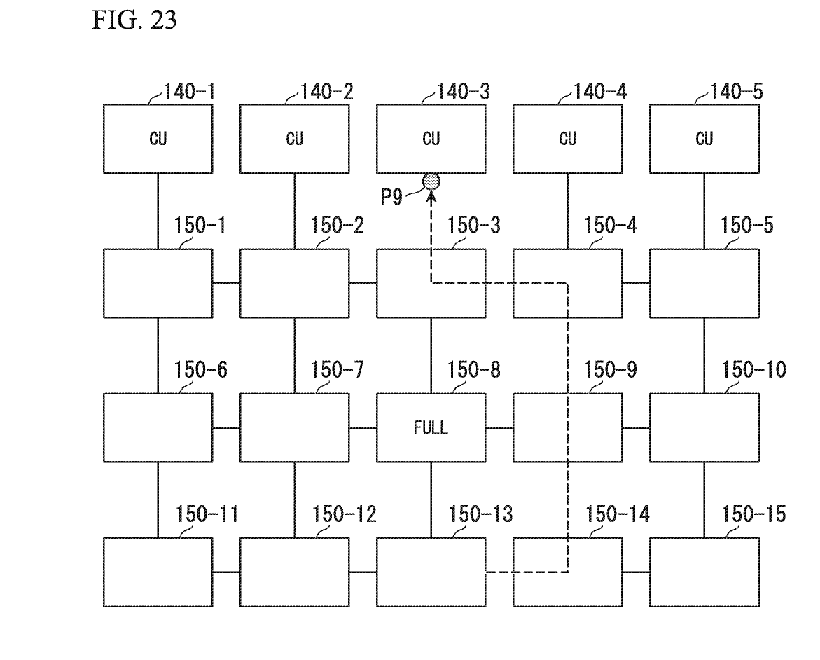

As shown in FIG. 23, the NM 150-13 transmits the generated response packet P9 to the CU 140-3. If the CU 140-3 receives the response packet P9 from the NM 150-13, the CU 140-3 generates a write request W4 for instructing the NM 150-13 to write data. At this time, the CU 140-3 extracts the congestion information described in the response packet P9, and the CU 140-3 describes the extracted congestion information in the payload area PA of the write request W4.

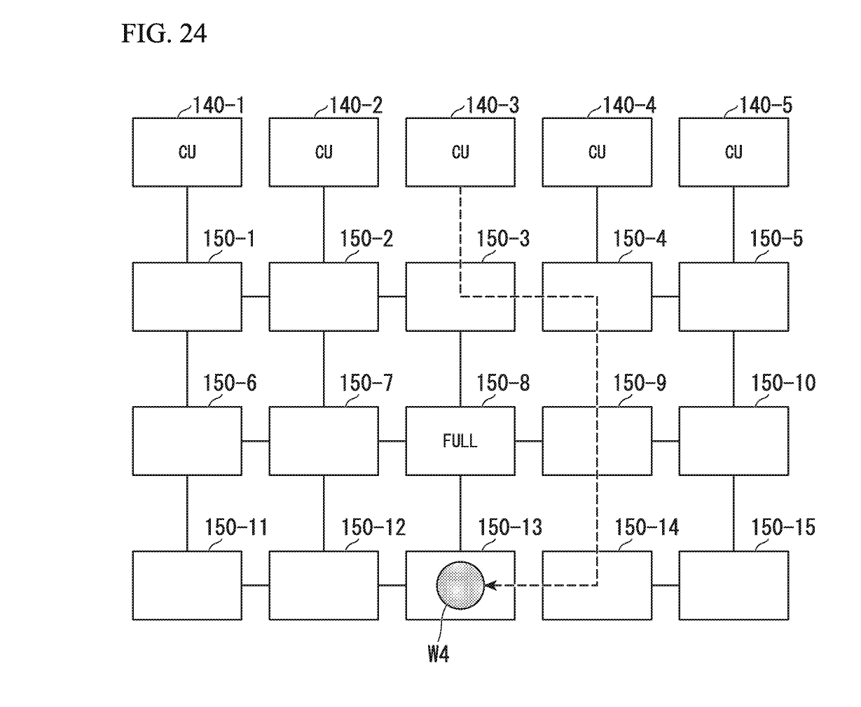

Thereafter, as shown in FIG. 24, the CU 140-3 transmits the generated write request W4 to the NM 150-13. At this time, each of the NMs 150 refers to the congestion information described in the payload area PA of the write request W4, and each of the NMs 150 transmits the write request W4 to the NM 150 that is different from the NM 150-8, which is in the PMU FULL state. Thereby, because the write request W4 passes through a communication path which does not include the NM 150-8 in the PMU FULL state, congestion in the communication network of the RCs 160 can be suppressed.

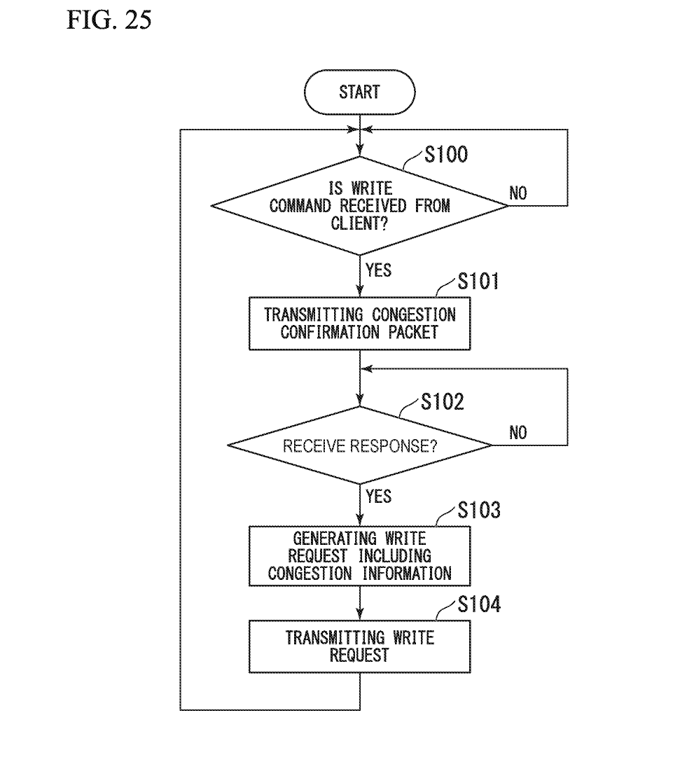

FIG. 25 is a flowchart illustrating an operation of the CU according to the fifth embodiment. The CU 140 determines whether or not the CU 140 receives a write command from the client 200 (step S100). If the CU 140 determines that the CU 140 receives the write command from the client 200, the CU 140 transmits the congestion confirmation packet P8 to the NM 150 (step S101).

Next, the CU 140 determines whether or not the CU 140 receives the response packet P9 from the NM 150 (step S102). If the CU 140 determines that the CU 140 receives the response packet P9 from the NM 150, the CU 140 generates the write request W4 for instructing the NM 150 to write data (step S103). At this time, the CU 140 extracts the congestion information described in the response packet P9, and the CU 140 describes the extracted congestion information in the payload area PA of the write request W4. The CU 140 transmits the generated write request W4 to the NM 150 (step S104), and the process returns to step S100.

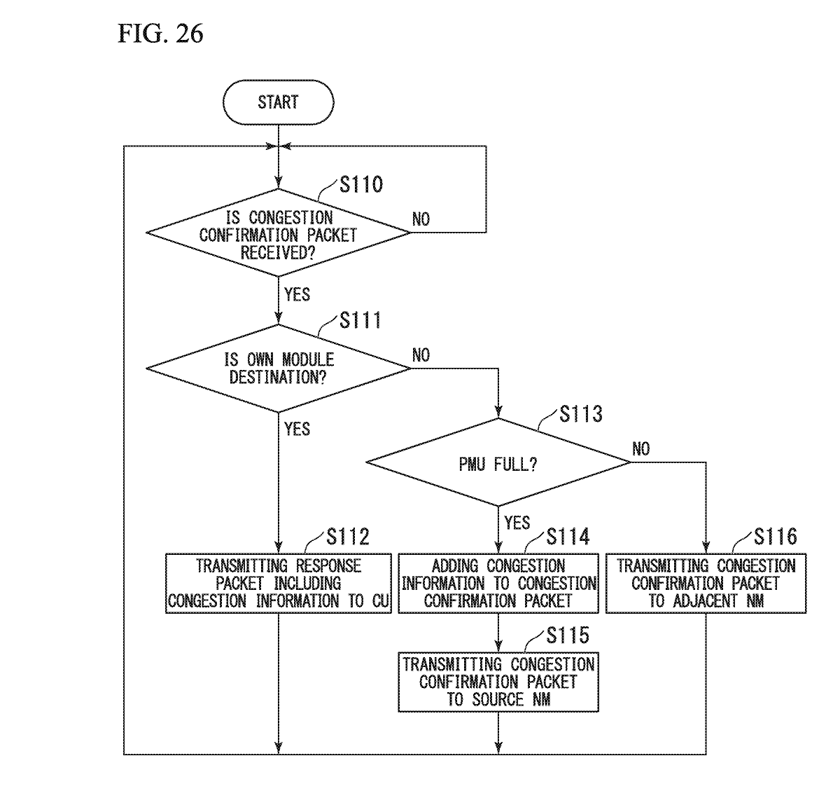

FIG. 26 is a flowchart illustrating an operation of the NM (FPGA) according to the fifth embodiment. The NM 150 determines whether or not the NM 150 receives the congestion confirmation packet P8 from the CU 140 (step S110). If the NM 150 determines that the NM 150 receives the congestion confirmation packet P8 from the CU 140, the NM 150 refers to the address of the destination described in the header area HA of the congestion confirmation packet P8, and the NM 150 determines whether or not the destination of the congestion confirmation packet P8 is the own module (step S111).

If the NM 150 determines that the destination of the congestion confirmation packet P8 is the own module, the NM 150 generates the response packet P9. At this time, NM 150 describes, in the payload area PA of the response packet P9, the congestion information included in the congestion confirmation packet P8. The NM 150 transmits the generated response packet P9 to the CU 140 (step S112), and the process returns to step S110.

On the other hand, in step S111, if the NM 150 determines that the destination of the congestion confirmation packet P8 is not the own module, the NM 150 determines whether or not the PMU 180 connected to the NM 150 is full of packets (whether or not the PMU 180 is in the PMU FULL state) (step S113).

If the NM 150 determines that the PMU 180 connected to the NM 150 is full of packets, the NM 150 adds information for identifying the own module, as the congestion information, to the payload area PA of the congestion confirmation packet P8 (step S114). Thereafter, the NM 150 returns the congestion confirmation packet P8 to an adjacent NM 150 which transmitted the congestion confirmation packet P8 (step S115), and the process returns to step S110.

On the other hand, in the step S113, if the NM 150 determines that the PMU 180 connected to the NM 150 is not full of packets, the NM 150 transmits the congestion confirmation packet P8 to an adjacent NM 150 (step S116). At this time, the NM 150 refers to the congestion information of the congestion confirmation packet P8, and the NM 150 transmits the congestion confirmation packet P8 to a path which does not include the NM 150 corresponding to the congestion information. If the NM 150 completes the transmission of the congestion confirmation packet P8, the process returns to step S110.

In the fifth embodiment, the congestion information is described in the congestion confirmation packet P8 in order to confirm the communication path along which congestion does not occur, but not limited thereto. For example, information for identifying the NM 150 which is not in the PMU FULL state may be described in the congestion confirmation packet P8 in order to confirm the communication path along which congestion does not occur.

As described above, according to the fifth embodiment, after the CU 140 confirms the communication path along which congestion does not occur, the CU 140 transmits the write request W4 to the NM 150 via the communication path along which congestion does not occur. Thereby, congestion in the communication network of the RCs 160 can be suppressed, and a writing performance of the storage system 100 may not be compromised.

In the first embodiment to the fifth embodiment, the CU 140 transmits the verification packet, the reservation packet, or the congestion confirmation packet to the NM 150 via the communication network of the RCs 160, but not limited thereto. For example, as shown in FIG. 7, a first line L1 may be provided in addition to a line L2, which is the connected described above in the first embodiment. The first line L1 directly connects the CU 140-3 and the NM 150-8 without passing through the communication network of the RCs 160 of intermediate NMs (i.e., NM 150-3), different from the second line L2 that connect the CU 140-3 and the NM 150-8 through the communication network of the RC 160s 160 of the intermediate NMs (i.e., NM 150-3). The first line L1 and the second line L2 are different at least in part from each other. The CU 140-3 may transmit the verification packet, the reservation packet, or the congestion confirmation packet through the first line L1 to the NM 150-8, and the CU 140-3 may transmit the write request through the second line L2 to the NM 150-8. Thereby, congestion in the communication network of the RCs 160 can be further suppressed. For example, the CU 140 may transmit the verification packet and the reservation packet to the NM 150 via a communication line, at least a part of which is not included in the communication network of the RCs 160. Specifically, communication lines may be connected from each of the CUs 140 to all of the RC 160, and the CU 140 may transmit the verification packet and the reservation packet to the NM 150 via the communication line. Thereby, because a number of the verification packets and the reservation packets, which pass through the communication network, can be reduced, congestion in the communication network can be further suppressed.

In the first embodiment or the second embodiment, the CU 140 verifies the load of the NM 150 based on the response to the verification packet, but not limited thereto. For example, the NM 150 may periodically determine whether or not the load is equal to or more than the reference value. If the load is equal to or more than the reference value, the NM 150 may generate an overload notice which indicates that the load is equal to or more than the reference value, and the NM 150 may transmit the overload notice to at least one of the CUs 140. The CU 140, which receives the overload notice, may not transmit a write request to the NM 150 which is a source of the overload notice. Also, the CU 140, which receives the overload notice from the NM 150, may transmit the overload notice to the other CUs 140. In this case, because it is not necessary for the CU 140 to transmit the verification packet to the NM 150, the load of the CU 140 can be reduced.

In at least one embodiment described above, the storage system 100 includes a plurality of the NMs 150 and a plurality of the CUs 140. The plurality of the NMs 150 transmits data to the NM 150, which is a write destination, via the communication network of the RCs 160. The plurality of the CUs 140 verifies that a load of the NM 150, which is a write destination, is less than the reference value, or performs a write reservation of data with respect to the NM 150 which is a write destination. Thereafter, the plurality of the CUs 140 transmits a write request to the NM 150 which is a write destination. Thereby, the writing performance of the storage system 100 may not be compromised.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
each of the connection units is configured to transmit an inquiry to a target node module, to initiate a write operation, and determine whether or not to transmit a write command to the target node module based on a notice returned by the target node module in response to the inquiry.

2. The storage device according to claim 1, wherein
each of the connection units determines to transmit the write command when the notice indicates acceptance of access, and determines to not transmit the write command when the notice indicates non-acceptance of access.

3. The storage device according to claim 2, wherein
each of the connection units is further configured to repeat to transmit the inquiry until the notice indicates acceptance of access.

4. The storage device according to claim 2, wherein
the notice indicates acceptance of access when a workload of the target node module is lower than a predetermined threshold, and non-acceptance of access when the workload is higher than a predetermined threshold.

5. The storage device according to claim 2, wherein
the target node module includes a counter, and is configured to increment a value of the counter in response to reception of the write command and decrement the value upon completion of a write operation based on the received write command, and
the notice indicates acceptance of access when the value of the counter is lower than a predetermined value and non-acceptance of access when the value of the counter is higher than the predetermined value.

6. The storage device according to claim 2, wherein
the target node module includes a counter, and is configured to increment a value of the counter in response to reception of the inquiry and decrement the value upon completion of a write operation based on the write command, and
the notice indicates acceptance of access when the value of the counter is lower than a predetermined value and non-acceptance of access when the value of the counter is higher than the predetermined value.

7. The storage device according to claim 1, wherein
each of the connection units accesses said each of the node modules through a shortest route along the network of the routing circuits.

8. A storage device, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
each of the connection units is configured to transmit an inquiry to a target node module, to initiate a write operation, and then write data to the target node module, and
the target node module is configured to register the inquiry in a registry, and write the write data into the nonvolatile memory in an order in which the inquiry has been registered in the registry.

9. The storage device according to claim 8, wherein
the target node module is further configured to delete the inquiry from the registry, upon completion of writing the corresponding write data.

10. The storage device according to claim 9, wherein
the target node module is further configured to return a request for write data to each of connection units that have transmitted the inquiry, in an order in which the inquiry has been registered in the registry, and
the write data are transmitted in response to the request.

11. The storage device according to claim 10, wherein
the target node module is further configured to transmit a notice to each of connection units that have transmitted the write data, upon completion of writing the corresponding write data, the notice including an identifier of a connection unit that has transmitted an oldest inquiry in the registry,
said each of the connection units is configured to transmit a second notice to another connection unit associated with the identifier in the notice,
the write data are transmitted from said another connection unit, in response to the second notice.

12. The storage device according to claim 8, wherein
each of the connection units accesses said each of the node modules through a shortest route along the network of the routing circuits.

13. A storage device, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
when a connection unit transmits an inquiry through a route to a target node module, to initiate a write operation with respect to the target node module, and at least one node module that is locally connected to an intermediary routing circuit that is located along the route and not locally connected to the target node module is busy, the inquiry is returned to the connection unit.

14. The storage device according to claim 13, wherein
the returned inquiry is transmitted to the target node module through a detour route that does not pass the intermediary routing circuit.

15. The storage device according to claim 14, wherein
the target node module is configured to transmit a notice in response to the inquiry, the notice being transmitted to the connection unit through the detour route.

16. The storage device according to claim 15, wherein
the connection unit is further configured to transmit write data in response to the notice, the write data being transmitted to the target node module through the detour route.

17. The storage device according to claim 14, wherein
when there is a second intermediary routing circuit along the path and between the connection unit and the intermediary routing circuit, the second intermediary routing circuit transmits the inquiry to the target node module through the detour route.

18. The storage device according to claim 13, wherein
an identifier of the busy node module is transmitted together with the returned inquiry.

19. The storage device according to claim 13, wherein
each of the connection units accesses said each of the node modules through a shortest route along the network of the routing circuits if none of node modules locally connected to one or more routing circuits along the shortest route is busy.
